SEQUENCE LISTING (10 sequences)

SEQ ID NO: 1 - protein, 478 aa, synthetic construct
MSPQTETKASAGFKAGVKDYKLNYYTPEYETKDTDILAAFRVTPQPGVPPEEAGAAVAAESSTGTWTTVWTDGLTSLDRYKGRCYHIEPVAGEENQFIAYIAYPLDLFEEGSVTNMFTSIVGNVFGFKALRALRLEDLRIPPAYSKTFQGPPHGIQVERDKLNKYGRPLLGCTIKPKLGLSAKNYGRAVYECLRGGLDFTKDDENVNSQPFMRWRDRFLFCAEAIYKAQAETGEIKGHYLNATAGTCEEMIKRAVFARELGVPIVMHDYLTGGFTANTSLAYYCRDNGLLLHIHRAMHAVIDRQKNHGMHFRVLAKALRMSGGDHVHSGTVVGKLEGEREMTLGFVDLLRDDFIEKDRSRGIFFTQDWVSMPGVLPVASGGIHVWHMPALTEIFGDDSVLQFGGGTLGHPWGNAPGAVANRVALEACVKARNEGRDLAREGNEIIREACNWSPELAAACEVWKEIKFEYEPVDKLDVK

SEQ ID NO: 2 - protein, 177 aa, synthetic construct
MASSMMASTAAAVARAGPAQSSMVPFNACRSSVPFPATRKANNNLSTLPGNGGRVSCMQVWPPEGLKKFETLSYLPPLSVEDLAKEVDYLLRNDWVPCIEFSKEGFVYRENHASPGYYDGRYWTMWKLPMFGCTDASQVIAEVEEAKKAYPEYFVRIIGFDNKRQVQCISFIAYKPT

SEQ ID NO: 3 - protein, 477 aa, synthetic construct
MSPQTETKASVGFKAGVKEYKLTYYTPEYQTKDTDILAAFRVTPQPGVPPEEAGAAVAAESSTGTWTTVWTDGLTSLDRYKGRCYRIERVVGEKDQYIAYVAYPLDLFEEGSVTNMFTSIVGNVFGFKALRALRLEDLRIPPAYVKTFQGPPHGIQVERDKLNKYGRPLLGCTIKPKLGLSAKNYGRAVYECLRGGLDFTKDDENVNSQPFMRWRDRFLFCAEALYKAQAETGEIKGHYLNATAGTCEEMIKRAVFARELGVPIVMHDYLTGGFTANTSLAHYCRDNGLLLHIHRAMHAVIDRQKNHGIHFRVLAKALRMSGGDHIHSGTVVGKLEGERDITLGFVDLLRDDFVEQDRSRGIYFTQDWVSLPGVLPVASGGIHVWHMPALTEIFGDDSVLQFGGGTLGHPWGNAPGAVANRVALEACVKARNEGRDLAQEGNEIIREACKWSPELAAACEVWKEIVFNFAAVDVLDK

SEQ ID NO: 4 - protein, 181 aa, synthetic construct
MAFLIMSSAAAVATGTNAAQASMIAPFTGLKSATSFPVSRKQNLDITSIASNGGRVQCMQVWPPINKKKYETLSYLPDLSEEQLLREVEYLLKNGWVPCLEFETEHGFVYRENNKSPGYYDGRYWTMWKLPMFGCTDATQVLAEVEEAKKAYPQAWIRIIGFDNVRQVQCISFIAYKPEGY

SEQ ID NO: 5 - protein, 474 aa, synthetic construct
MSPQTETKATVGFKAGVKDYRLTYYTPDYETKDTDILAAFRVSPQPGVPAEEAGAAVAAESSTGTWTTVWTDGLTSLDRYKGRCYHIEPVAGEETQFIAYVAYPLDLFEEGSVNYMFTSIVGNVFGFKALRALRLEDLRIPAAYVKTFQGPPQGIQVERDKLNKYGRPLLGCTIKPKLGLSAKNYGRAVYECLRGGLDFTKDDENVNSQPFMRWRDRFLFCAEAIYKAQAETGEIKGHYLNATAGTCEEMMKRAVFARELGVPIVMHDYLTVGFTANTTLAHYCRDNGLLLHIHRAMHAVIDRQKNHGMHFRVLAKALRMSGGDHIHAGTVVGKLEGERDITLGFVDLLRDDFIEKDRSRGIFFTQDWVSLPGVLPVASGGIHVWHMPALTEIFGDDSVLQFGGGTLGHPWGNAPGAVANRVALEACVQARNEGRDLAREGNEIIREATKWSPELAAACEVWKEIKFEFPAMDN

SEQ ID NO: 6 - protein, 180 aa, synthetic construct
MALISSAAVTTVNRASSAQANLVAPFTGLKSSAGFPVTKKTNNDITSIASNGGRVNCMQVWPPVGKKKFETLSYLPPLTEEQLAKEVEYLIRKGWIPCLEFELEKGFVYRENHRSPGYYDGRYWTMWRLPLFGATDSSQVLKELADCKAEYPDSFIRIIGFDNVRQVQCISFIAHTPKNY

SEQ ID NO: 7 - protein, 475 aa, synthetic construct
MSPQTETKASVEFKAGVKDYKLTYYTPEYETLDTDILAAFRVSPQPGVPPEEAGAAVAAESSTGTWTTVWTDGLTNLDRYKGRCYHIEPVAGEENQYICYVAYPLDLFEEGSVTNMFTSIVGNVFGFKALRALRLEDLRIPVAYVKTFQGPPHGIQVERDKLNKYGRPLLGCTIKPKLGLSAKNYGRAVYECLRGGLDFTKDDENVNSQPFMRWRDRFLFCAEALYKAQAETGEIKGHYLNATAGTCEDMMKRAVFARELGVPIVMHDYLTGGFTANTTLSHYCRDNGLLLHIHRAMHAVIDRQKNHGMHFRVLAKALRLSGGDHIHSGTVVGKLEGERDITLGFVDLLRDDYTEKDRSRGIYFTQSWVSTPGVLPVASGGIHVWHMPALTEIFGDDSVLQFGGGTLGHPWGNAPGAVANRVALEACVQARNEGRDLAREGNTIIREATKWSPELAAACEVWKEIKFEFPAMDTV

SEQ ID NO: 8 - protein, 123 aa, synthetic construct
MQVWPPLGLKKFETLSYLPPLTTEQLLAEVNYLLVKGWIPPLEFEVKDGFVYREHDKSPGYYDGRYWTMWKLPMFGGTDPAQVVNEVEEVKKAPPDAFVRFIGFNDKREVQCISFIAYKPAGY

SEQ ID NO: 9 - protein, 475 aa, synthetic construct
MSPQTETKARVGFKAGVKDYRLTYYTPDYQPKDTDILAAFRMTPQPGVPPEEAGAAVAAESSTGTWTTVWTDGLTSLDRYKGRCYDIEPVPGEENQYIAYIAYPLDLFEEGSVTNLFTSIVGNVFGFKALRALRLEDLRIPPAYVKTFQGPPHGIQVERDKLNKYGRGLLGCTIKPKLGLSAKNYGRAVYECLRGGLDFTKDDENVNSQPFMRWRDRFLFVAEAIYKSQAETGEIKGHYLNATAATAEAMMQRAECAKDLGVPIIMHDYLTGGFTANTSLSHYCRDNGLLLHIHRAMHAVIDRQRNHGITFRVLAKALRLSGGDHLHSGTVVGKLEGEREVTLGFVDLMRDDYIEKDRSRGIYFTQDWVSLPGTMPVASGGIHVWHMPALVEIFGDDACLQFGGGTLGHPWGNAPGAAANRVALEACTQARNEGRDLAREGGDVIRAACKWSPELAAACEVWKEIKFEFETIDTL

SEQ ID NO: 10 - protein, 214 aa, synthetic construct
MAALTASLVSCPVAVAAKPARLASPAWPASLSPRRLSPPSPRGPSQTAAAPARCSCGSPLTTSSSRPSPTCPSDRRPDRQAGRLHHPSGWTPALEFSNAESAYVKDVANIRFTGGSASCNYYDNRYWAMYKLPMFGCTDASQVLAEIANAVKTFPDSYVRMAAFDAVRQVQTVAILVHRPASATDYRLPENPQPLIGCTTQLERPQYCKSLANL

(19) United States
(12) Patent Application Publication
(10) Pub. No.: US 2024/0358041 A1
(43) Pub. Date: Oct. 31, 2024

(54) Directional Freezing of Ribulose-1,5-Bisphosphate Carboxylate-Oxygenase (RUBISCO)

(71) Applicant: Plantible Foods Inc., San Marcos, CA (US)

(72) Inventors: Parker LEE, Poway, CA (US); Tony MARTENS FEKINI, Encinitas, CA (US); Nina CILLIERS, Encinitas, CA (US)

(21) Appl. No.: 18/771,484

(22) Filed: Jul. 12, 2024

Related U.S. Application Data
(63) Continuation of application No. PCT/US2023/060574, filed on Jan. 12, 2023.
(60) Provisional application No. 63/299,521, filed on Jan. 14, 2022.

(51) Int. Cl. A23J 3/14; A23J 3/26; A23L 13/30; A23L 13/40

(52) U.S. Cl. CPC A23J 3/14; A23J 3/26; A23L 13/30; A23L 13/426; A23L 13/43; A23L 13/48

(57) ABSTRACT

Provided herein are methods for making an extruded protein product using a high-moisture extrusion technique is described. High moisture extrudates described can allow for a high inclusion of oil without disrupting a fibrous structure formation during cooling and provides an improved fatty mouthfeel perception upon consumption. Also provided herein are directionally frozen highly fibrous scaffolds generated from a solution of a ribulose 1,5-bisphosphate carboxylase/oxygenase (RuBisCO) protein isolate, an additive, and water. Described are compositions where a structure or strength of the directionally frozen highly fibrous scaffold is modulated in relation in part to a concentration of the RuBisCO protein isolate and temperatures of setting of the directionally frozen highly fibrous scaffold and other additives. The directionally frozen highly fibrous scaffold may be post-processed to serve as a whole-cut meat product or is used as a fibrous and protein-rich scaffold for cell culturing to generate a hybrid cultivated meat product.

### CROSS-REFERENCE

This application is a continuation of PCT Application No. PCT/US2023/060574, filed Jan. 12, 2023, which claims benefit of U.S. Provisional Application No. 63/299,521, filed on Jan. 14, 2022, which are incorporated herein by reference in their entirety.

### SEQUENCE LISTING

The instant application contains a Sequence Listing which has been submitted electronically in ST.26 (xml) format and is hereby incorporated by reference in its entirety. Said ST.26 (xml) copy, created on Jul. 10, 2024, is named 2000834_706301_SL.xml and is 12,939 bytes in size.

### BACKGROUND

Plant-based food products provide numerous health benefits to the consumer as compared to the food products they replace. Specifically, plant-based food products are non-animal-based replicas of animal-based food products and may include drinks, meats, cheeses, eggs, pastes, pate, etc. As an example, a plant-based meat product may be a meat replica and may be made to mimic the look, texture, and taste of the animal-based product, such that is similar to, or indistinguishable from, the given food product.

Recent developments in extrusion technologies have resulted in the production of extruded protein products made from animal derived and/or non-animal derived protein sources, which have oriented fibers that are texturally similar to meat. Specifically, plant-based meat analogues may be produced using low-moisture or high-moisture extrusion processes. Products prepared by low-moisture extrusion processes have a porous structure and the texture does not resemble that of an animal the product replaces. In contrast, high-moisture extrusion processes can create an end product with a fibrous meat-like structure from plant protein raw materials. Specifically, during the high-moisture extrusion process, plant proteins are unfolded, aggregated and realigned with heat, pressure, and shear in an extruder barrel. In a cooling die, the protein molecules are cross-linked, leading to the formation of a fibrous meat-like structure.

The fibrous structure of the plant-based meat analogues formed from a high-moisture extrusion process (e.g., a “high-moisture meat analogue”) is dependent on several factors, including an amount and a type of proteins in the raw material. Empirical evidence historically suggests that there is a limit of about 50% protein concentration in the raw material, with protein concentrations below this limit negatively affecting the ability to create a fibrous texture in the extrudate. Coupled with the high demand for plant-based meat analogues, a need exists for a production method that utilizes unique protein isolates to produce an extruded protein product having meat-like properties.

### BRIEF SUMMARY

In some embodiments, are methods of heating compositions, the methods comprising: heating a composition comprising a frozen ribulose-1,5-bisphosphate carboxylase/oxygenase (RuBisCO) protein isolate to generate a heated RuBisCO composition comprising a substantially unidirectional morphology and a substantially uniform structure in a solid form, wherein the substantially unidirectional morphology comprises a macroscopic fibrous structure comprising interconnected vertical bundles of the heated RuBisCO composition. In some embodiments, the heating partially dehydrates the heated RuBisCO composition. In some embodiments, the heating dehydrates the heated RuBisCO composition. In some embodiments, the heating of the composition generates a heated RuBisCO composition that is a food product precursor. In some embodiments, are methods of preparing a structured food product precursor comprising: providing a composition comprising a ribulose-1,5-bisphosphate carboxylase/oxygenase (RuBisCO) protein isolate from a plant and a solvent; freezing the composition to form a frozen composition; dehydrating the composition to form a frozen, dehydrated composition; and heating the frozen composition to form a structured food product precursor, wherein the structured food product precursor has a macroscopic fibrous structure. In some embodiments, are methods of preparing a composition, the methods comprising: providing a composition comprising: a ribulose-1,5-bisphosphate carboxylase/oxygenase (RuBisCO) protein isolate from a plant and a solvent; freezing the composition to form a frozen composition; exposing the composition to a freeze-dryer replacement bath, thereby generating a frozen composition; and heating the dehydrated frozen composition to form a food product precursor, wherein the structured plant protein food precursor product has a macroscopic fibrous structure. In some embodiments, are compositions, wherein the composition comprise: a ribulose-1,5-bisphosphate carboxylase/oxygenase (RuBisCO) protein isolate; a solvent; and an additive, wherein when a portion of the composition is subjected to uniform geometry analysis, the portion comprises a 38 mm diameter and a height of 15 mm, wherein the portion comprises a hardness of 10 to 70 Newtons (N) when hardness is measured by a first compression event using a Mecmesin MultiTest 2.51 device, and/or wherein the food product has a cohesiveness of 20 to 60 percent when measured by calculating the area under the second compression cycle divided by the area under the first compression cycle using a Mecmesin MultiTest 2.5 device. In some embodiments, is a composition, wherein the composition is in a solid form with unidirectional morphology, and comprises: a RuBisCO protein isolate composition, wherein the unidirectional morphology comprises interconnected vertical bundles of the RuBisCO protein isolate. In some embodiments, is a composition, wherein the composition is in a solid form with at least one region of unidirectional morphology, and comprises: a RuBisCO protein isolate composition, wherein the at least one region of unidirectional morphology comprises interconnected vertical bundles of the RuBisCO protein isolate. In some embodiments is a method of preparing a rehydrated RuBisCO composition, the method comprising exposing a baked RuBisCO composition to a second composition comprising water, oil, a flavoring agent, a pH control, a salt, or a fat substitute at a temperature of 4-95 degrees Celsius for 1 minute to 48 hours. In some embodiments, provided herein are methods for making an extruded protein product using a high-moisture extrusion technique, the method comprising: producing a stream comprising a proteinaceous composition, wherein the proteinaceous composition comprises at least one protein component capable of forming oriented fibers; directing the stream through an elongated channel of a die to form the oriented fibers from the at least one protein component in a generally parallel orientation to form an extruded protein product; and cooling the stream to provide the oriented fibers throughout a thickness of the extruded protein product. In some embodiments, also provided herein are high moisture extrudates comprising: about 40-50 wt. % of a dry blend of components; about 30-60 wt. % of water; and about 0-20 wt. % of a ribulose 1,5-bisphosphate (RuBP) carboxylase/oxygenase (RuBisCO) emulsion. In some embodiments, also provided herein are directionally frozen highly fibrous scaffolds generated from a solution of a ribulose 1,5-bisphosphate (RuBP) carboxylase/oxygenase (RuBisCO) protein isolate, an additive, and water.

### BRIEF DESCRIPTION OF THE DRAWINGS

FIG. 1 depicts a schematic diagram of a high moisture extrusion process to form an extruded protein product, according to at least some embodiments disclosed herein.

FIG. 2 depicts a block diagram of a method, according to at least some embodiments disclosed herein.

FIG. 3 depicts images a block diagram of RuBisCO meat product formation via directional freezing.

FIG. 4 depicts images of a high moisture extrusion process setup on a Thermo Process 11 extruder, according to at least some embodiments disclosed herein.

FIG. 5 depicts images of soy protein concentrate extrudates produced with varied levels of RuBisCO protein isolate, according to at least some embodiments disclosed herein. Samples 130, 132, and 134 are soy protein concentrate extrudate samples where: sample 130 has 0% RuBisCO protein isolate; sample 132 has 10% RuBisCO protein isolate; and sample 134 has 20% RuBisCO protein isolate.

FIG. 6 depicts a graph depicting shear strength of soy protein concentrate extrudates, according to at least some embodiments disclosed herein, including shear strength measurements for samples 130, 132, and 134 shown in FIG. 4.

FIG. 7 depicts images of soy protein concentrate extrudates produced with varied levels of RuBisCO protein isolate, according to at least some embodiments disclosed herein. Samples 146, 148, 150, and 152 are soy protein concentrate extrudate samples where: sample 146 has 0% RuBisCO protein isolate; sample 148 has 10% RuBisCO protein isolate; sample 150 has 20% RuBisCO protein isolate and sample 152 has 50% RuBisCO protein isolate.

FIG. 8 depicts a graph depicting shear strength of soy protein concentrate extrudates, according to at least some embodiments disclosed herein, including shear strength measurements for samples 146, 148, 150, and 152 shown in FIG. 7.

FIG. 9 depicts images of dried directionally frozen RuBisCO fibrous scaffolds, according to at least some embodiments disclosed herein.

FIG. 10 depicts magnified images using a stereoscope of heat-set RuBisCO (food product precursor) prior to rehydration. RuBisCO isolate solutions used to form these solids had RuBisCO isolate concentration of: 5, 10, 20, and 30 weight percent (left to right).

FIG. 11 shows a graphical representation of increasing measurements of hardness versus RuBisCO isolate concentration used in the RuBisCO isolate starting solution.

FIG. 12 shows a graphical representation comparing bundle sizes of food product precursors with different additives used in the RuBisCO isolate starter solutions.

FIG. 13 shows a graphical representation comparing hardness of food product with different additives used in the RuBisCO isolate starter solutions.

FIG. 14 shows a graphical representation comparing the hardness of meat food products prepared with different amounts of a fat additive.

FIG. 15A and FIG. 15B shows a graphical representations of the resulting average bundle diameter of directionally frozen compositions a function of the temperature used for freezing.

FIG. 16 shows a graphical representation of hardness as a function of time heated for food product precursors.

FIG. 17 shows a graphical representation of the hardness and cohesiveness of meat food products generated from RuBisCO in comparison with animal based meats.

FIG. 18 shows a graphical representation of the hardness and cohesiveness of meat food products generated from RuBisCO in comparison with other plant-based meat food products.

FIG. 19 depicts images of meat product precursors for each of the plant-based proteins considered.

### DETAILED DESCRIPTION

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

### Definitions

The following definitions supplement those in the art and are directed to the current application and are not to be imputed to any related or unrelated case, e.g., to any commonly owned patent or application. Although any methods and materials similar or equivalent to those described herein are used in the practice for testing of the present disclosure, the preferred materials and methods are described herein. Accordingly, the terminology used herein is for the purpose of describing particular embodiments only, and is not intended to be limiting.

Herein, the use of the singular includes the plural unless specifically stated otherwise. It must be noted that, as used in the specification, the singular forms “a,” “an” and “the” include plural referents unless the context clearly dictates otherwise. Furthermore, use of the term “including” as well as other forms, such as “include”, “includes,” and “included,” is not limiting. The phrase “and/or,” as used herein in the specification and in the claims, should be understood to mean “either or both” of the elements so conjoined, e.g., elements that are conjunctively present in some cases and disjunctively present in other cases. Thus, as anon-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless specifically stated or obvious from context, as used herein, the term “about” in reference to a number or range of numbers is understood to mean the stated number and numbers +/−10% thereof, or 10% below the lower listed limit and 10% above the higher listed limit for the values listed for a range.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps. It is contemplated that any embodiment discussed in this specification can be implemented with respect to any method or composition of the present disclosure, and vice versa. Furthermore, compositions of the present disclosure can be used to achieve methods of the present disclosure.

Reference herein to “some embodiments,” “an embodiment,” “one embodiment” or “other embodiments” means that a particular feature, structure, or characteristic described in connection with the embodiments can be included in at least some embodiments, but not necessarily all embodiments, of the present disclosure.

As used herein, “identity,” refers to a relationship between two or more peptide/polypeptide sequences, as determined by comparing the sequences. In the art, “identity” also refers to the degree of sequence relatedness between polypeptide sequences as determined by the match between strings of such sequences. “Identity” can be readily calculated by any suitable method. Preferred methods to determine identity are designed to give the largest match between the sequences tested. Methods to determine identity are codified in publicly available computer programs. The percent identity between two sequences can be determined by using any suitable analysis software that incorporates the Needelman and Wunsch algorithm (e.g., NBLAST, and XBLAST). The default parameters are used to determine the identity for the polypeptides of the present disclosure, unless stated otherwise.

As used herein, the term “% similarity” used in the context of an amino acid sequence, refers to a value that is calculated by dividing a similarity score by the length of the alignment. The similarity of two amino acid sequences can be calculated by using a BLOSUM62 similarity matrix (Henikoff and Henikoff, Proc. Natl. Acad. Sci. USA., 89:10915-10919 (1992)) that is transformed so that any value ≥1 is replaced with +1 and any value ≤0 is replaced with 0. For example, an Ile (I) to Leu (L) substitution is scored at +2.0 by the BLOSUM62 similarity matrix, which in the transformed matrix is scored at +1. This transformation allows the calculation of percent similarity, rather than a similarity score. Alternately, when comparing two full protein sequences, the proteins can be aligned using pairwise MUSCLE alignment. Then, the % similarity can be scored at each residue and divided by the length of the alignment. For determining % similarity over a protein domain or motif, a multilevel consensus sequence (or PROSITE motif sequence) can be used to identify how strongly each domain or motif is conserved. In calculating the similarity of a domain or motif, the second and third levels of the multilevel sequence are treated as equivalent to the top level. Additionally, if a substitution could be treated as conservative with any of the amino acids in that position of the multilevel consensus sequence, +1 point is assigned. For example, given the multilevel consensus sequence: RLG and YCK, the test sequence QIQ would receive three points. This is because in the transformed BLOSUM62 matrix, each combination is scored as: Q-R: +1; Q-Y: +0; I-L: +1; I-C: +0; Q-G: +0; Q-K: +1. For each position, the highest score is used when calculating similarity. The % similarity can also be calculated using commercially available programs, such as the Geneious Prime software given the parameters matrix=BLOSUM62 and threshold ≥1.

As used herein, the term “protein” refers to a molecule comprised of amino acid residues, at least two of which are covalently linked by peptide bonds. A protein contains at least two amino acids or amino acid variants, and no limitation is placed on the maximum number of amino acids that can comprise a protein sequence. The term “protein isolate” refers to aa preparation of proteins, wherein the proteins has been substantially separated from non-protein components of a mixture. The “purity” of a protein isolate refers to the amount of protein relative to the total amount of protein preparation. In some embodiments, the purity of the protein isolate is expressed as a percentage of the total dry mass.

As used herein, the terms “proteinaceous composition” includes at least one protein component and water. As used herein, the terms “protein component” includes at least one non-animal derived protein and/or animal derived protein. Examples of non-animal derived proteins include proteins derived from plants, algae, bacteria, fungi, or yeast, among others not explicitly listed herein. More specifically, examples of non-animal derived proteins may include crude mixtures of proteins or partially or fully purified proteins in the form of protein concentrates or protein isolates. In examples described herein, the terms “protein isolate” indicates that the protein content is greater than about 80%, 85%, 90%, or 95%. Examples of the partially or fully purified proteins in the form of protein concentrates or protein isolates include: zein, gluten, soy protein, pea, RuBisCO, etc.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also, unless otherwise stated, include individual values (e.g., about 1%, about 2%, about 3%, about 4%, etc.) and the sub-ranges (e.g., about 0.5% to about 1.1%; about 0.5% to about 2.4%; about 0.5% to about 3.2%, about 0.5% to about 4.4%, and other possible sub-ranges, etc.) within the indicated range.

### Overview

The present disclosure provides systems, compositions, and products comprising a protein component, and methods of making the same. In some embodiments, compositions provided herein are proteinaceous compositions. In some embodiments, products provided herein are an extruded protein product. In some embodiments, methods provided herein are methods of making compositions described herein, such as proteinaceous compositions. In some embodiments, methods provided herein are methods of making products described herein, such as an extruded protein product. In some embodiments, the disclosure relates to use of a ribulose-1,5-bisphosphate carboxylase/oxygenase (RuBisCO) protein isolate RuBisCO protein isolate. In some embodiments, the RuBisco is that is chlorophyll-free, colorless, and flavorless and has gelation and other techno-functional properties. In some embodiments, a RuBisCO meat food product is generated comprising directional freezing. In some embodiments, a RuBisCO meat food product is generated comprising directional freezing of a RuBisCO isolate solution. In some embodiments, a RuBisCO meat food product is generated comprising directional freezing and dehydration. In some embodiments, a RuBisCO meat food product precursor is generated comprising directional freezing, dehydration and heating. In some embodiments, a structured RuBisCO meat food product precursor is generated comprising directional freezing, dehydration and heating. In some embodiments, a RuBisCO meat food product precursor is hydrated to form RuBisCO meat food product. In some embodiments, a structured RuBisCO meat food product precursor is hydrated to form RuBisCO meat food product.

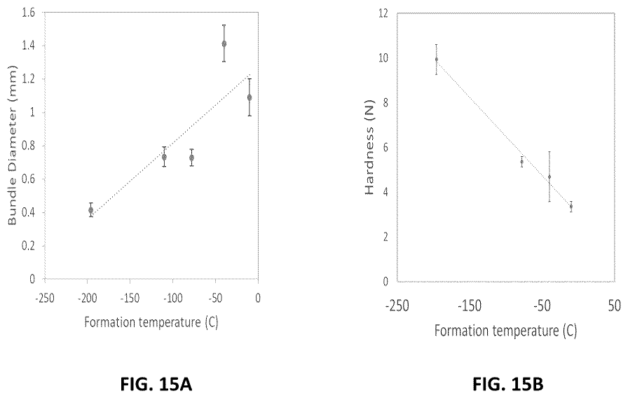

In some embodiments, a composition comprising directionally frozen RuBisCO has a macroscopic fibrous structure. In some embodiments, the macroscopic fibrous structure comprises visible bundles in the structure. In some embodiments the bundles are quantitatively analyzed as shown in FIG. 15A and FIG. 15B.

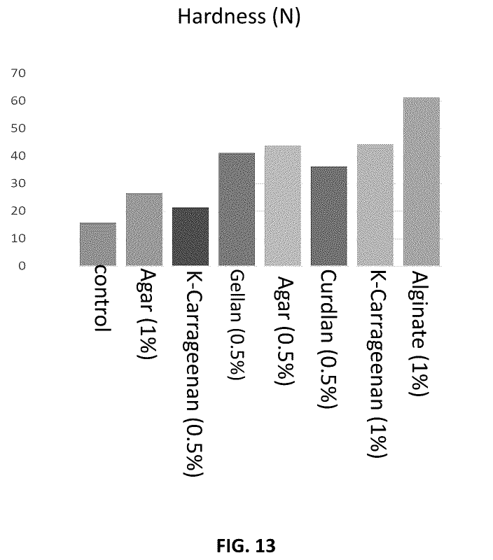

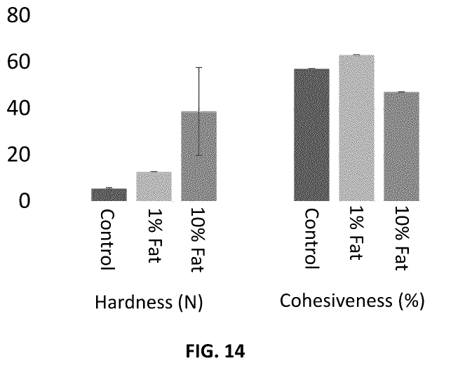

In some embodiments, a RuBisCO meat food product prepared herein comprises an additive. In some embodiments, a RuBisCO meat food product prepared herein comprises an additive that results in distinct morphological characteristics as shown in FIG. 13 and FIG. 14.

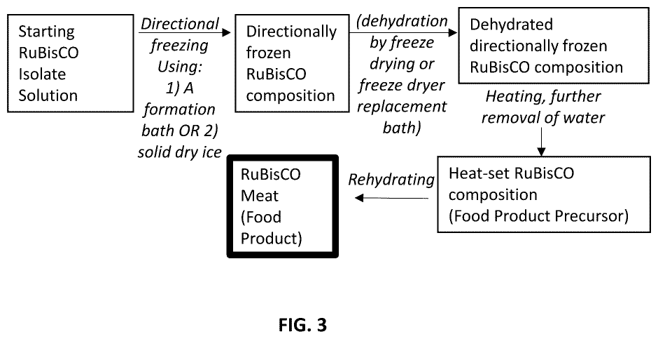

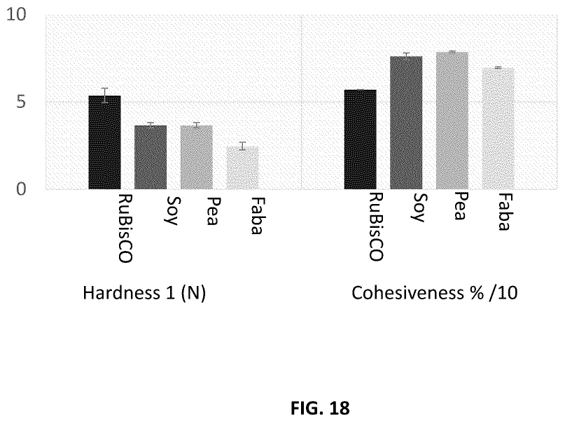

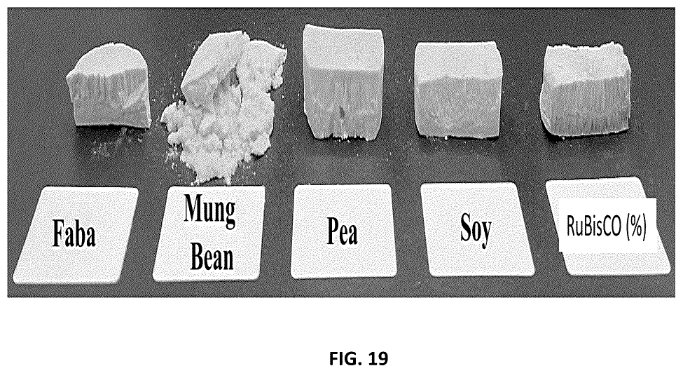

In some embodiments are methods to generate a RuBisCO meat food product according to FIG. 3. In some embodiments, methods of generating a RuBisCO meat food product comprise directional freezing. In some embodiments, methods of generating a RuBisCO meat food product comprise dehydrating a directionally frozen RuBisCO composition using a solvent replacement bath method. In some embodiments, the morphological characteristics of a RuBisCO meat food product precursor are analyzed. In some embodiments, the morphological characteristics of a RuBisCO meat food product are analyzed. In some embodiments, RuBisCO meat food products prepared herein have quantitative measurements of hardness in comparison to other plant-based protein meat products and animal based protein meat products as shown in FIG. 18 and FIG. 19.

### Compositions

Compositions provided herein comprise at least one protein component and/or a use thereof. In some embodiments, a composition provided herein comprises an aqueous solution or a use thereof. In some embodiments, a composition provided herein comprises one or more additives. In some embodiments, a composition described herein is a proteinaceous composition. In some embodiments, a protein component described herein capable of forming oriented fibers. In some embodiments, a proteinaceous composition comprises at least one protein component and an aqueous solution.

### Protein Component

In some embodiments, the at least one protein component is selected from the group consisting of: a RuBisCO protein isolate, a soy protein concentrate or isolate, and a pea protein concentrate or isolate.

In some embodiments, the at least one protein component exhibits or comprises: (1) clean label gelation properties, (2) a high emulsification ability with no added emulsifier, (3) a complete protein nutritional profile, (4) an ability to form a stable emulsion that is thermally gelled, (5) an ability to be conveniently dissolved, (6) an ability to be formed into fibrous or aligned structures and then set, (7) a high protein content and nutritional value for cultivated meat hybrid products, (8) an ability to produce diverse products that can be easily fabricated from one protein source, or any combination of (1)-(8).

In some embodiments, one or more protein isolates are at least about 30%, 40%, 50%, 60%, 70%, 80%, 90%, 95%, or more isolated proteins. In some embodiments, the purity of the one or more protein isolate described herein is 80% or more. In certain embodiments, the one or more protein isolates described herein may contain no more than 50%, 40%, 30%, 20% 10% or less impurities. In certain embodiments, the one or more protein isolates described herein may contain no more than 20% 10% or less impurities. In some embodiments, one or more protein isolates are present in about 1 g to about 100 g or more. In some embodiments, one or more protein isolates are present in about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, or more.

### RuBisCO Protein Isolate

In some embodiments, a RuBisCO protein isolate is isolated and/or purified from a naturally occurring source (such as, for example, a plant, algae, bacterium, or the like). In some embodiments, a RuBisCO protein isolate is isolated and/or purified from a photosynthesizing plant (e.g., one or more plants of the Nicotiana species) or a photosynthesizing organism (e.g., photosynthetic bacteria). In some embodiments, RuBisCO protein isolate is (or at least a portion of or all of the RuBisCO protein isolate are isolated and/or purified from a plant (such as, for example, duckweed, fungi, protist, algae, cyanobacteria and/or proteobacteria that expresses RuBisCO, or the like). In some embodiments, RuBisCO protein isolate is isolated and/or purified from a member of the Amaranthaceae, Araceae, Poaceae, Solanaceae, or Apiaceae family. In some embodiments, RuBisCO protein isolate is isolated and/or purified from a member of the Lemna, Spirodela, Wolffia, Wolffiella, Spinacia, Beta, Leymus, Nicotiana, Zea, Solanum, Daucus, Atriplex, Nannochloropsis, Chlorella, Dunaliella, Scenedesmus, Selenastrum, Oscillatoria, Phormidium, Spirulina, Amphora, or Ochromona genus. In some embodiments, RuBisCO protein isolate is a plant RuBisCO, such as, for example, a RuBisCO from (e.g., isolated and/or purified from) a plant of genus Lemna or genera Lemnaceae.

In some embodiments, RuBisCO protein isolate is isolated and/or purified from one or more of the following species: Lemna aequinoctialis, Lemna disperma, Lemna ecuadoriensis, Lemna gibba (swollen duckweed), Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Leymus arenarius, Zea mays, Daucus carota, Solanum tuberosum, Atriplex lentiformis, Scendesmus dimorphus, Pereskia aculeata, Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima, Amphora delicatissima var. capitata, Amphora sp., Anabaena, Ankistrodesmus, Ankistrodesmus falcatus, Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomas perigranulata, Chlorella anitrata, Chlorella antarctica, Chlorella aureoviridis, Chlorella Candida, Chlorella capsulate, Chlorella desiccate, Chlorella ellipsoidea, Chlorella emersonii, Chlorella fusca, Chlorella fusca var. vacuolate, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella salina, Chlorella simplex, Chlorella sorokiniana, Chlorella sp., Chlorella sphaerica, Chlorella stigmatophora, Chlorella vanniellii, Chlorella vulgaris, Chlorella vulgaris fo. tertia, Chlorella vulgaris var. autotrophica, Chlorella vulgaris var. viridis, Chlorella vulgaris var. vulgaris, Chlorella vulgaris var. vulgaris fo. tertia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Gleocapsa sp., Gloeothamnion sp., Haematococcus pluvialis, Hymenomonas sp., lsochrysis aff galbana, lsochrysis galbana, Lepocinclis, Micractinium, Micractinium, Monoraphidium minutum, Monoraphidium sp., Nannochloris sp., Nannochloropsis salina, Nannochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrine, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Platymonas sp., Pleurochrysis camerae, Pleurochrysis dentate, Pleurochrysis sp., Prototheca wickerhamii, Prototheca stagnora, Prototheca portoricensis, Prototheca moriformis, Prototheca zopfli, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf Tagetes erecta, Tagetes patula, Tetraedron, Tetraselmis sp., Tetraselmis suecica, Thalassiosira weissflogii, and Viridiella fridericiana. In some embodiments, RuBisCO protein isolate is from (e.g., isolated and/or purified from) Lemna minor, Lemna gibea, or the like. In some embodiments, a RuBisCO polypeptide is from (e.g., isolated and/or purified from) common duckweed or the like.

It should be appreciated RuBisCO is considered the most abundant plant protein known and is an enzyme involved in the first major step of carbon fixation, a process by which the atmospheric carbon dioxide is converted by plants and other photosynthetic organisms to energy-rich molecules such as glucose. More specifically, RuBisCO catalyzes the carboxylation of ribulose-1,5-bisphosphate (or “RuBP”). When subjected to heating and other processing, particularly in an aqueous slurry, RuBisCO is known to exhibit various functional properties that may be desirable in a protein source, such as: solubility, viscosity building, gel formation, water retention, foaming, and emulsifying attributes.

In some embodiments, RuBisCO proteins may be extracted from a photosynthesizing plant (e.g., one or more plants of the Nicotiana species) or a photosynthesizing organism (e.g., photosynthetic bacteria). In some embodiments, the RuBisCO protein isolate is free of chlorophyll, is flavorless, is colorless, and may be extracted from a photosynthesizing plant or a photosynthesizing organism.

In some embodiments, RuBisCO proteins are extracted from lemna minor. Lemna minor is a floating freshwater aquatic plant, with one, two, three, or four leaves, each having a single root hanging in the water. Lemna minor has a subcosmopolitan distribution and is native throughout most of Africa, Asia, Europe and North America. It is present wherever freshwater ponds and slow-moving streams occur, except for arctic and subarctic climates.

In some embodiments, the RuBisCO protein isolate is free of chlorophyll, is flavorless, is colorless, and may be extracted from a photosynthesizing plant or a photosynthesizing organism. In some embodiments, RuBisCO can also be flavorless, tasteless, colorless, and/or uncolored. Subsequent to extraction, RuBisCO proteins may be further processed to improve the purity of the protein sample. In other scenarios, the extracted RuBisCO may undergo further processing (e.g., adjusting the pH, adjusting the heat, etc.) in order to concentrate the extracted proteins. Additionally, extracted RuBisCO proteins may also be combined with other proteins, where such combination may occur before or after the additional processing described. In some embodiments, RuBisCO protein isolate comprises other proteins, including but not limited to: pea proteins, isolates, and/or concentrates; garbanzo (chickpea) proteins, isolates, and/or concentrates; fava bean proteins, isolates, and/or concentrates; soy proteins, isolates, and/or concentrates; rice proteins, isolates, and/or concentrate; potato proteins, isolates, and/or concentrates; hemp proteins, isolates, and/or concentrates; canola proteins, isolates, and/or concentrates; wheat proteins, isolates, and/or concentrates; corn proteins, isolates, and/or concentrates; zein proteins, isolates, and/or concentrates; rice proteins, isolates, and/or concentrates; oat proteins, isolates, and/or concentrates; potatoes proteins, isolates, and/or concentrates; peanut proteins, isolates, and/or concentrates; legumes/pulses proteins, isolates, and/or concentrates; lentils proteins, isolates, and/or concentrates; or any combinations thereof. RuBisCO protein and other protein combinations. In some examples, RuBisCO and additional proteins may be in a dry form (e.g., powdered, pelletized, or the like). In other examples, the RuBisCO and the additional proteins may be in a liquid form or in a liquid solution.

In some embodiments, the RuBisCO protein isolate comprises protein comprising a sequence that has at least about 60%, 65%, 70%, 75%, 80%, 85%, 90%, 95%, 99%, or about 100% sequence identity with any one of the sequences as set forth in TABLE 1. In some embodiments, the RuBisCO protein isolate comprises protein comprising a sequence that has at least about 60%, 65%, 70%, 75%, 80%, 85%, 90%, 95%, 99%, or about 100% sequence identity with more than one of the sequences as set forth in TABLE 1. In some embodiments, the RuBisCO protein isolate comprises protein comprising a sequence that has at least about 60%, 65%, 70%, 75%, 80%, 85%, 90%, 95%, 99%, or about 100% sequence identity with one or more of the sequences as set forth in SEQ ID NOS: 1 to 10. Provided in TABLE 1 are large and small RuBisCO subunits for various species described herein, including Lemna minor, Nicotiana tabacum, Medicago sativa (alfalfa), Spinacia oleracea (Spinach), and Chlorella vulgaris (green algae).

In some embodiments, a RuBisCO protein isolate comprises a polypeptide having an amino acid sequence that is about 70% to about 100%, including all 0.1 percent values and ranges therebetween, identical to one or more of any one of the sequences set forth in TABLE 1, and/or to any one of the sequences set forth in the unitprot.org record indicated by the accession identifiers set forth in TABLE 2.

In some embodiments, a RuBisCO protein isolate comprises a polypeptide having an amino acid sequence that is about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 percent similar to one or more of any one of the sequences set forth in TABLE 1, and/or to any one of the sequences set forth in the unitprot.org record indicated by the accession identifiers set forth in TABLE 2.

In some embodiments, a RuBisCO protein isolate comprises a polypeptide having an amino acid sequence that is about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 percent identical to one or more of any one of the sequences set forth in TABLE 1, and/or to any one of the sequences set forth in the unitprot.org record indicated by the accession identifiers set forth in TABLE 2.

In some embodiments, a RuBisCO protein isolate is a variant, homolog, ortholog, paralog, derivative, or any combination thereof is about 70, to 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 percent similar to one or more of any one of the sequences set forth in TABLE 1, and/or to any one of the sequences set forth in the unitprot.org record indicated by the accession identifiers set forth in TABLE 2. 100561 In some embodiments, a RuBisCO protein isolate is a variant, homolog, ortholog, paralog, derivative, or any combination thereof is about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 percent identical to one or more of any one of the sequences set forth in TABLE 1, and/or to any one of the sequences set forth in the unitprot.org record indicated by the accession identifiers set forth in TABLE 2.

TABLE 1
RUBISCO SEQUENCES

| SEQ ID | |
|---|---|
| NO: | Sequence |
| 1 | MSPQTETKASAGFKAGVKDYKLNYYTPEYETKDTDILAAFRVTPQPGVPPEEAGA |
| | AVAAESSTGTWTTVWTDGLTSLDRYKGRCYHIEPVAGEENQFIAYIAYPLDLFEE |
| | GSVTNMFTSIVGNVFGFKALRALRLEDLRIPPAYSKTFQGPPHGIQVERDKLNKYG |
| | RPLLGCTIKPKLGLSAKNYGRAVYECLRGGLDFTKDDENVNSQPFMRWRDRFLF |
| | CAEAIYKAQAETGEIKGHYLNATAGTCEEMIKRAVFARELGVPIVMHDYLTGGFT |
| | ANTSLAYYCRDNGLLLHIHRAMHAVIDRQKNHGMHFRVLAKALRMSGGDHVHS |
| | GTVVGKLEGEREMTLGFVDLLRDDFIEKDRSRGIFFTQDWVSMPGVLPVASGGIH |
| | VWHMPALTEIFGDDSVLQFGGGTLGHPWGNAPGAVANRVALEACVKARNEGRD |
| | LAREGNEIIREACNWSPELAAACEVWKEIKFEYEPVDKLDVK |
| 2 | MASSMMASTAAAVARAGPAQSSMVPFNACRSSVPFPATRKANNNLSTLPGNGGR |
| | VSCMQVWPPEGLKKFETLSYLPPLSVEDLAKEVDYLLRNDWVPCIEFSKEGFVYR |
| | ENHASPGYYDGRYWTMWKLPMFGCTDASQVIAEVEEAKKAYPEYFVRIIGFDNK |
| | RQVQCISFIAYKPT |
| 3 | MSPQTETKASVGFKAGVKEYKLTYYTPEYQTKDTDILAAFRVTPQPGVPPEEAGA |
| | AVAAESSTGTWTTVWTDGLTSLDRYKGRCYRIERVVGEKDQYIAYVAYPLDLFE |
| | EGSVTNMFTSIVGNVFGFKALRALRLEDLRIPPAYVKTFQGPPHGIQVERDKLNKY |
| | GRPLLGCTIKPKLGLSAKNYGRAVYECLRGGLDFTKDDENVNSQPFMRWRDRFL |
| | FCAEALYKAQAETGEIKGHYLNATAGTCEEMIKRAVFARELGVPIVMHDYLTGG |
| | FTANTSLAHYCRDNGLLLHIHRAMHAVIDRQKNHGIHFRVLAKALRMSGGDHIH |
| | SGTVVGKLEGERDITLGFVDLLRDDFVEQDRSRGIYFTQDWVSLPGVLPVASGGI |
| | HVWHMPALTEIFGDDSVLQFGGGTLGHPWGNAPGAVANRVALEACVKARNEGR |
| | DLAQEGNEIIREACKWSPELAAACEVWKEIVFNFAAVDVLDK |
| 4 | MAFLIMSSAAAVATGTNAAQASMIAPFTGLKSATSFPVSRKQNLDITSIASNGGRV |
| | QCMQVWPPINKKKYETLSYLPDLSEEQLLREVEYLLKNGWVPCLEFETEHGFVYR |
| | ENNKSPGYYDGRYWTMWKLPMFGCTDATQVLAEVEEAKKAYPQAWIRIIGFDN |
| | VRQVQCISFIAYKPEGY |
| 5 | MSPQTETKATVGFKAGVKDYRLTYYTPDYETKDTDILAAFRVSPQPGVPAEEAG |
| | AAVAAESSTGTWTTVWTDGLTSLDRYKGRCYHIEPVAGEETQFIAYVAYPLDLFE |
| | EGSVNYMFTSIVGNVFGFKALRALRLEDLRIPAAYVKTFQGPPQGIQVERDKLNK |
| | YGRPLLGCTIKPKLGLSAKNYGRAVYECLRGGLDFTKDDENVNSQPFMRWRDRF |
| | LFCAEAIYKAQAETGEIKGHYLNATAGTCEEMMKRAVFARELGVPIVMHDYLTV |
| | GFTANTTLAHYCRDNGLLLHIHRAMHAVIDRQKNHGMHFRVLAKALRMSGGDH |
| | IHAGTVVGKLEGERDITLGFVDLLRDDFIEKDRSRGIFFTQDWVSLPGVLPVASGGI |
| | HVWHMPALTEIFGDDSVLQFGGGTLGHPWGNAPGAVANRVALEACVQARNEGR |
| | DLAREGNEIIREATKWSPELAAACEVWKEIKFEFPAMDN |
| 6 | MALISSAAVTTVNRASSAQANLVAPFTGLKSSAGFPVTKKTNNDITSIASNGGRVN |
| | CMQVWPPVGKKKFETLSYLPPLTEEQLAKEVEYLIRKGWIPCLEFELEKGFVYRE |
| | NHRSPGYYDGRYWTMWRLPLFGATDSSQVLKELADCKAEYPDSFIRIIGFDNVRQ |
| | VQCISFIAHTPKNY |
| 7 | MSPQTETKASVEFKAGVKDYKLTYYTPEYETLDTDILAAFRVSPQPGVPPEEAGA |
| | AVAAESSTGTWTTVWTDGLTNLDRYKGRCYHIEPVAGEENQYICYVAYPLDLFE |
| | EGSVTNMFTSIVGNVFGFKALRALRLEDLRIPVAYVKTFQGPPHGIQVERDKLNK |
| | YGRPLLGCTIKPKLGLSAKNYGRAVYECLRGGLDFTKDDENVNSQPFMRWRDRF |
| | LFCAEALYKAQAETGEIKGHYLNATAGTCEDMMKRAVFARELGVPIVMHDYLT |
| | GGFTANTTLSHYCRDNGLLLHIHRAMHAVIDRQKNHGMHFRVLAKALRLSGGD |
| | HIHSGTVVGKLEGERDITLGFVDLLRDDYTEKDRSRGIYFTQSWVSTPGVLPVASG |
| | GIHVWHMPALTEIFGDDSVLQFGGGTLGHPWGNAPGAVANRVALEACVQARNE |
| | GRDLAREGNTIIREATKWSPELAAACEVWKEIKFEFPAMDTV |
| 8 | MQVWPPLGLKKFETLSYLPPLTTEQLLAEVNYLLVKGWIPPLEFEVKDGFVYREH |
| | DKSPGYYDGRYWTMWKLPMFGGTDPAQVVNEVEEVKKAPPDAFVRFIGFNDKR |
| | EVQCISFIAYKPAGY |
| 9 | MSPQTETKARVGFKAGVKDYRLTYYTPDYQPKDTDILAAFRMTPQPGVPPEEAG |
| | AAVAAESSTGTWTTVWTDGLTSLDRYKGRCYDIEPVPGEENQYIAYIAYPLDLFE |
| | EGSVTNLFTSIVGNVFGFKALRALRLEDLRIPPAYVKTFQGPPHGIQVERDKLNKY |
| | GRGLLGCTIKPKLGLSAKNYGRAVYECLRGGLDFTKDDENVNSQPFMRWRDRFL |
| | FVAEAIYKSQAETGEIKGHYLNATAATAEAMMQRAECAKDLGVPIIMHDYLTGG |
| | FTANTSLSHYCRDNGLLLHIHRAMHAVIDRQRNHGITFRVLAKALRLSGGDHLHS |
| | GTVVGKLEGEREVTLGFVDLMRDDYIEKDRSRGIYFTQDWVSLPGTMPVASGGIH |
| | VWHMPALVEIFGDDACLQFGGGTLGHPWGNAPGAAANRVALEACTQARNEGRD |
| | LAREGGDVIRAACKWSPELAAACEVWKEIKFEFETIDTL |
| 10 | MAALTASLVSCPVAVAAKPARLASPAWPASLSPRRLSPPSPRGPSQTAAAPARCS |
| | CGSPLTTSSSRPSPTCPSDRRPDRQAGRLHHPSGWTPALEFSNAESAYVKDVANIR |
| | FTGGSASCNYYDNRYWAMYKLPMFGCTDASQVLAEIANAVKTFPDSYVRMAAF |
| | DAVRQVQTVAILVHRPASATDYRLPENPQPLIGCTTQLERPQYCKSLANL |

TABLE 2
RUBISCO SUBUNITS

| Subunit | Uniprot Accession Number |
|---|---|
| Large | A9L9A4, A0A3GlN0S3, K4Fl51, A0A3GlMVZ6, H9ALP2, D6NJG9, Q8WHI2, |
| | G8D4W8, D3W4G8, H9ALP3, G0WYT7, B5WX54, A0A1S7JIB4, A0A482K3Y6, |
| | R9S086, A0A411PP11, D6NJG2, H9AHZ6, Q8WHI1, R4I7N5, 085040, Q31NB3, |
| | P00880, P00875, P00879, O93627, O03042, P0C2C2, P04718, P00877, P0C512, |
| | P04717, P00876, Pll383, P22849, Q8DIS5, P22859, 085040, B0Z5Bl, Q31HD8, |
| | P22850, |
| Small | P19309, P19308, P19310, P19311, Pl9312, P00872, P10795, B3H5S2, P10796, |
| | P10797, A0A0S4IJL0, P45686, P04716, P69249, Q0INY7, Q31NB2, P05348, |
| | P08475, P00873, |

In some embodiments, a composition comprises one or more fragment(s) of a RuBisCO polypeptide (which may be referred to as RuBisCO polypeptide fragments) in a RuBisCO protein isolate. In some embodiments, a RuBisCO polypeptide fragment is composed of about 4 to about 478 contiguous amino acids of a RuBisCO polypeptide, including all integer number of contiguous amino acids and ranges therebetween, but is less than the full-length native or wild-type RuBisCO polypeptide. In some embodiments, a RuBisCO polypeptide fragment is 4, to/or 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475 contiguous amino acids of a RuBisCO polypeptide but is less than the full-length native or wild-type RuBisCO polypeptide. In some embodiments, a fragment is a functional domain of the RuBisCO polypeptide.

Protein isolates described herein can comprise various amounts of RuBisCO(s). In some embodiments, a protein isolate comprises about 80 to about 100 percent by weight (e.g., about 83 to about 86 percent by weight) (e.g., based on the total weight of the composition), including all 0.1 weight percent values and ranges therebetween, crude RuBisCO protein(s) and/or polypeptide(s). In some embodiments, crude RuBisCO protein(s) and/or polypeptide(s) comprise(s) about 60 to about 100% percent by weight (e.g., about 75 to about 85) percent by weight) (based on the total weight of the composition), including all 0.1 weight percent values and ranges therebetween, RuBisCO(s).

In some embodiments, compositions disclosed herein can comprise about 5% to about 80%, about 6% to about 50%, about 7% to about 40%, about 8% to about 30%, about 9% to about 20%, or about 10% to about 15% RuBisCO protein isolate by dry weight or total weight. In some embodiments, compositions disclosed herein can comprise about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, or more RuBisCO protein isolate by dry weight or total weight.

In some embodiments, compositions disclosed herein can comprise about 1 g to about 100 g of additional protein isolate. In some embodiments, compositions disclosed herein can comprise about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, or more RuBisCO protein isolate by dry weight or total weight.

In some embodiments, the present disclosure describes a method for making an extruded protein product using a high-moisture extrusion technique. The method includes numerous process steps, such as: producing a stream comprising a proteinaceous composition. In some embodiments, the stream is produced using an extruder, such as: a single screw extruder, a twin extruder, a triple screw extruder, or a ring extruder, among others not explicitly listed herein.

### Aqueous Solution

Compositions disclosed herein can further comprise an aqueous solution. Compositions herein can comprise about 1 wt % to about 100 wt % by weight of an aqueous solution. In some embodiments, an aqueous solution can comprise water, alcohol, acids, such as citric acid and/or ascorbic acid, or another liquid substance. In some embodiments, the liquid comprises glycerol (glycerine). In certain embodiments, an aqueous solution can comprise a preservative, and may be referred to herein as a preservative solution. Such a preservative solution can comprise water, and one or more acids. In some embodiments, the aqueous solution comprises a pH adjusting agent described herein.

Compositions herein can comprise about 1%, about 10%, about 20%, about 30%, about 40%, about 50%, about 60%, about 70%, about 80%, about 90%, about 95%, about 96%, about 97%, about 98%, about 99%, or about 100% by weight of aqueous solution. Compositions herein can comprise about 10 g, about 20 g, about 30 g, about 40 g, about 50 g, about 60 g, about 70 g, about 80 g, about 90 g, about 100 g, about 110 g, about 120 g, about 130 g, about 140 g, about 150 g, about 160 g, about 170 g, about 180 g, about 190 g, about 200 g, about 210 g, about 220 g, about 230 g, about 240 g, about 250 g, about 260 g, about 270 g, about 280 g, about 290 g, about 300 g or more of an aqueous solution.

In some embodiments, an aqueous solution can comprise water, an acid, abase, solutes, soluble salts, or combinations thereof. In some embodiments, solutes can include polysaccharides, such as dissolved polysaccharide to make an aqueous polysaccharide solution. In some embodiments, an aqueous solution is water.

### Additives

In some embodiments, compositions described herein comprise RuBisCO protein isolate and an additive. In some embodiments, compositions described herein comprise RuBisCO protein isolate and at least one additive. In some embodiments, the additive results in a composition described herein with a distinct texture properties of: a frozen RuBisCO, a RuBisCO food product precursor, a RuBisCO meat food product, or a combination of any of these. In some embodiments, the additive results in a composition described herein with a distinct bundle diameter size of the macroscopic fibrous structure of a composition described herein. In some embodiments the composition is: a frozen RuBisCO composition, a directionally frozen RuBisCO composition, a RuBisCO food product precursor, a RuBisCO meat food product, or a combination of any of these. In some embodiments, a food product precursor is a structured food product precursor.

In some embodiments, compositions provided herein may further comprise one or more additives. One or more additives comprise: an additional protein isolate, an additional protein concentrate, an animal-derived protein, a protein isolate, a starch, a gum, a flavor or a flavoring agent, a salt, a dye, a preservative, a colorant or coloring agent, a lipid, a hydrocolloid, a carbohydrate, a softener or polyol, an enzyme, a pH adjusting agent, a nutrient (such as a macronutrient, a micronutrient, a vitamin, a mineral, or combinations thereof), or combinations thereof among others not explicitly listed herein. In some embodiments, compositions provided herein further comprise a fiber, a starch, and/or a lecithin. Examples of additives are described herein, however, it should be appreciated that these examples are provided for illustrative purposes only and are non-limiting. In some embodiments, the additive is added to the RuBisCO protein isolate starter solution to adjust the structure, textural parameters, flavor, appearance, or shelf-life of the resulting RuBisCO meat food product.

An embodiment of the subject matter described herein includes a plant-based food product that includes a protein isolate, a food component, and a food additive. The protein isolate can comprise a ribulose-1,5-bisphosphate carboxylase/oxygenase (RuBisCO) protein isolate. The protein isolate can comprise a protein content greater than approximately 80%. Furthermore, the protein isolate is free of chlorophyll, is flavorless, and is colorless.

In some embodiments, the food additive is a plasticizer, an oil, a sugar, a flavoring component, a coloring component, a fiber, a soluble salt, a starch, an acid, and/or a wax, among others not explicitly listed herein. The plasticizer may be water, an aqueous polysaccharide solution, an alcohol, a polyalcohol, a glycerol (glycerine), a gum Arabic, a xanthan gum, a guar gum, a locust bean gum, and/or an aqueous solution of carbohydrates, an amino acid, amino acids (e.g., cysteine, cystine, or lysine), polypeptides among others not explicitly listed herein. Further, the coloring component may be a turmeric component, among others not explicitly listed herein.

Additionally, the fiber may be pectin, citrus fiber, and/or cellulose, among others not explicitly listed herein. In some examples, the soluble salt may be calcium lactate gluconate, among others not explicitly listed herein. In other examples, the acid may be ascorbic acid and/or citric acid, among others not explicitly listed herein. In some embodiments, the oil may be a safflower oil, a coconut oil, a grapeseed oil, and/or a canola oil, among others not explicitly listed herein. Further, the wax may be a naturally-derived wax or a synthetic wax. In examples, the plant-based food product may be a milk replacement product or an egg replacement product.

In some embodiments, a higher percent weight of an additive can result in increased hardness of a food product precursor. In some embodiments, a higher percent weight of an additive can result in increased hardness of a meat food product. In some embodiments, a higher percent weight of an additive can result in smaller bundle diameters of a directionally frozen RuBisCO composition. In some embodiments, a higher percent weight of an additive can result in smaller bundle diameters of a food product precursor. In some embodiments, a higher percent weight of an additive can result in smaller bundle diameters of a heated and dried food product precursor.

In some embodiments, the additive is hydrated at an increased temperature, cooled, and then added to a solution comprising RuBisCO. In some embodiments, the additive is dispersed in water prior to the addition of RuBisCO protein isolate. In some embodiments, the additive is dispersed in water prior to the addition of RuBisCO protein isolate at room temperature. In some embodiments, the additive is dispersed in an aqueous solution prior to the addition of RuBisCO protein isolate. In some embodiments, the additive is dispersed in an aqueous solution concurrently with the addition of RuBisCO protein isolate. In some embodiments, the additive is dispersed in an aqueous solution after the addition of RuBisCO protein isolate to the aqueous solution. In some embodiments, the additive is dispersed in an aqueous solution prior to the addition of RuBisCO protein isolate at room temperature or at an increased temperature, cooled, and then added to a solution comprising RuBisCO. In some embodiments, the additive is dispersed in an aqueous solution concurrently with the addition of RuBisCO protein isolate at room temperature or at an increased temperature, cooled, and then added to a solution comprising RuBisCO. In some embodiments, an additive is combined with a cross-linking agent described herein. In some embodiments, an additive is combined with at least one cross-linking agent described herein. In some embodiments, the cross-linking agent comprises epigallocatechin gallate. In some embodiments, the cross-linking agents comprise epigallocatechin or tamarind seed extract. In some embodiments, the cross-linking agents comprise epigallocatechin and tamarind seed extract. In some embodiments, the linking agent comprise alginate. In some embodiments, the additive comprises a gelling agent. In some embodiments, the gelling agent comprises calcium ions. In some embodiments, a composition described herein comprises an additive that is crosslinked by calcium ions. In some embodiments, calcium ions are added to a frozen composition described herein. In some embodiments, calcium ions are added to a frozen RuBisCO composition. In some embodiments, calcium ions are added to a directionally frozen RuBisCO composition. In some embodiments, the calcium ions are added to a composition described herein in an external solvent bath.

In some embodiments, compositions provided herein comprise 0.01% to about 10% of an additive by weight. In some embodiments, compositions disclosed herein comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3% or more an additive by weight.

Compositions may comprise 0.1 g to about 1 g of additive by weight. In some embodiments, compositions disclosed herein comprise about 0.1 g, about 0.2 g, about 0.3 g, about 0.4 g, about 0.5 g, about 0.6 g, about 0.7 g, about 0.8 g, about 0.9 g, about 1 g or more of an additive.

### Additional Protein Isolate

Compositions described herein may comprise one or more additional protein isolates or a use thereof. Examples of the protein isolate include, but are not limited to, a pea protein isolate, a faba bean protein isolate, a wheat protein isolate, a soy protein isolate, a mung bean protein isolate, a sunflower protein isolate, a canola protein isolate, a potato protein isolate, a RuBisCO protein isolate, a rice protein isolate, a hemp protein isolate, a lentil protein isolate, a chickpea protein isolate, a pumpkin protein isolate, a transglutaminase, a tyrosine oxidase, a lysyl oxidase, or combinations thereof.

In some embodiments, compositions disclosed herein can comprise about 5% to about 80%, about 6% to about 50%, about 7% to about 40%, about 8% to about 30%, about 9% to about 20%, or about 10% to about 15% additional protein isolate by dry weight or total weight. In some embodiments, compositions disclosed herein can comprise about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, or more additional protein isolate by dry weight or total weight.

In some embodiments, compositions disclosed herein can comprise about 1 g to about 100 g of additional protein isolate. In some embodiments, compositions disclosed herein can comprise about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, or more additional protein isolate by dry weight or total weight.

### Additional Protein Concentrate

Compositions described herein may comprise one or more additional protein concentrates or a use thereof. Examples of the protein concentrate include, but are not limited to, a pea protein concentrate, a faba bean protein concentrate, a wheat protein concentrate, a soy protein concentrate, a mungbean protein concentrate, a sunflower protein concentrate, a canola protein concentrate, a potato protein concentrate, a RuBisCO protein concentrate, a rice protein concentrate, a hemp protein concentrate, a lentil protein concentrate, a chickpea protein concentrate, a pumpkin protein concentrate, or combinations thereof.

In some embodiments, compositions disclosed herein can comprise about 5% to about 80%, about 6% to about 50%, about 7% to about 40%, about 8% to about 30%, about 9% to about 20%, or about 10% to about 15% additional protein concentrate by dry weight or total weight. In some embodiments, compositions disclosed herein can comprise about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, or more additional protein concentrate by dry weight or total weight.

In some embodiments, compositions disclosed herein can comprise about 1 g to about 100 g of additional protein concentrate. In some embodiments, compositions disclosed herein can comprise about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, or more additional protein concentrate by dry weight or total weight.

### Animal-Derived Protein

In some embodiments, the plant-based food products are made to replicate or replace nutritional or functional characteristics in food products, such as to produce an equivalent meat product. The equivalent meat product is derived from any animal, such as cattle, sheep, pig, chicken, turkey, goose, duck, horse, dog, rabbit, deer, bison, buffalo, boar, snake, pheasant, quail, bear, elk, antelope, pigeon, dove, grouse, fox, wild pig, goat, kangaroo, emu, alligator, crocodile, turtle, groundhog, marmot, possum, partridge, squirrel, raccoon, whale, seal, ostrich, capybara, nutria, guinea pig, any variety of insect or other arthropod, or seafood. Examples of plant-based food products created may include any plant-based food product, including, but not limited to drinks, meats, cheeses, eggs, pastes, pate, etc. The plant-based meat product may be a meat replica and may be made to mimic the look, texture, and taste of the animal-based product, such that is similar to, or indistinguishable from, the given food product.

In some embodiments, isolated and purified protein describe herein are enriched relative to starting material (e.g., plants or other non-animal sources). In some embodiments, the term “isolated and purified” can indicate that the preparation of the protein is at least 60% pure, e.g., greater than 65%, 70%, 75%, 80%, 85%, 90%, 95%, or 99% pure. The isolated and purified protein or the protein isolate may be derived from a non-animal source, such as plants, algae, fungi (e.g., yeast or filamentous fungi), bacteria, or Archaea.

Compositions described herein may comprise one or more animal-derived proteins or a use thereof. Examples of animal-derived proteins include proteins derived from an animal source, such as: cattle, sheep, pig, chicken, turkey, goose, duck, horse, dog, rabbit, deer, bison, buffalo, boar, snake, pheasant, quail, bear, elk, antelope, pigeon, dove, grouse, fox, wild pig, goat, kangaroo, emu, alligator, crocodile, turtle, groundhog, marmot, possum, partridge, squirrel, raccoon, whale, seal, ostrich, capybara, nutria, guinea pig, rat, mice, vole, any variety of insect or other arthropod, seafood, or combinations thereof.

In some embodiments, compositions disclosed herein can comprise about 5% to about 80%, about 6% to about 50%, about 7% to about 40%, about 8% to about 30%, about 9% to about 20%, or about 10% to about 15% animal-derived proteins by dry weight or total weight. In some embodiments, compositions disclosed herein can comprise about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, or more animal-derived proteins by dry weight or total weight.

In some embodiments, compositions disclosed herein can comprise about 1 g to about 100 g of animal-derived proteins. In some embodiments, compositions disclosed herein can comprise about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, or more animal-derived proteins by dry weight or total weight.

### Starch

Compositions described herein can further comprise one or more starches, such as, for example, arrowroot starch, chickpea starch, corn starch, tapioca starch, mung bean starch, pea starch, potato starch, sweet potato starch, rice starch, sago starch, wheat starch. The term “starch” can refer to polysaccharide materials, which when produced in plants, can act as energy stores. In some embodiments, starches are used to impart thickening and stabilizing properties. In some embodiments the starch comprises a polysaccharide. In some embodiments, the polysaccharide is naturally occurring. In some embodiments, the polysaccharide is added from an external source.

In some embodiments, compositions described herein can include about 1%, about 2%, about 3%, about 4%, about 5%, about 6%, about 7%, about 8%, about 9%, about 10%, or more by weight of starch. In some embodiments, compositions described herein can include about 0.5-20%, about 1-15%, or about 2-10% by weight of starch, for example Compositions described herein can include about 1 g, about 2 g, about 3 g, about 4 g, about 5 g, about 6 g, about 7 g, about 8 g, about 9 g, about 10 g or more of a starch.

### Lecithin

In some embodiments, compositions described herein can comprise a surfactant. In some embodiments, the surfactant comprises at least one glycerophospholipid. In some embodiments, the at least one glycerophospholipid comprises phosphatidylcholine, phosphatidylethanolamine, phosphatidylinositol, phosphatidylserine, or phosphatidic acid. In some embodiments, the at least one glycerophospholipid comprises phosphatidylcholine, phosphatidylethanolamine, phosphatidylinositol, phosphatidylserine, and phosphatidic acid. Compositions described herein can further include lecithin. In some embodiments, the surfactant comprises at least one lecithin. Lecithins can be yellow, brownish, fatty substances that are found in animal and plant tissues, and animal product tissues, such as egg yolk. Lecithin can act as an emulsifier, and can have a similar fat profile to that of natural eggs. Lecithins can also be non-allergenic. In some embodiments, compositions described herein can comprise lecithin, such as plant-based lecithin. Examples of lecithins included in compositions disclosed herein include garbanzo lecithin, fava bean lecithin, soy lecithin, sunflower lecithin, canola lecithin, or a combination thereof. In some embodiments, compositions described herein can comprise about 0.01%, about 0.02%, about 0.03%, about 0.04%, about 0.05%, about 0.06%, about 0.07%, about 0.08%, about 0.09%, about 0.1%, about 0.2%, 0.25%, about 0.3%, about 0.4%, about 0.5%, about 0.6%, about 0.7%, about 0.8%, about 0.9%, about 1.0%, or more by weight of lectin. In some embodiments, compositions described herein can comprise about 0.01 g, about 0.02 g, about 0.03 g, about 0.04 g, about 0.05 g, about 0.06 g, about 0.07 g, about 0.08 g, about 0.09 g, about 0.1 g, about 0.2 g, about 0.3 g, about 0.4 g, about 0.5 g, about 0.6 g, about 0.7 g, about 0.8 g, about 0.9 g, about 1.0 g, about 1.5 g, about 2.0 g, 2.5 g, about 3.0 g, about 3.5 g, about 4.0 g, 4.5 g, about 5.0 g, about 5.5 g, about 6.0 g, 6.5 g, about 7.0 g, about 7.5 g, about 8.0 g, 8.5 g, about 9.0 g, about 9.5 g, about 10.0 g, or more of a lectin.

In some embodiments are compositions comprising RuBisCO protein isolate and lecithin. In some embodiments, the lecithin is a chemically modified lecithin. In some embodiments, the chemically modified lecithin is a hydroxylated lecithin. In some embodiments the lecithin is deodorized. In some embodiments, the lecithin has an enzymatic modification. In some embodiments, a ratio by weigh of RuBisCO protein isolate:lecithin is about 1:1. In some embodiments, a ratio by weigh of RuBisCO protein isolate:lecithin is up to 1, 2, 3, 5, 6, 7, 8, 9, 10, 15, 20, 50 times by weight. In some embodiments, a ratio by weigh of RuBisCO protein isolate:lecithin is up to about 1, 2, 3, 5, 6, 7, 8, 9, 10, 15, 20, 50 times by weight.

### Crosslinking Agent

In further examples, one or more other additives may also be included in the compositions described herein, such as glossing agents or crosslinking agents. A crosslinking agent may be used to promote desirable changes in a disclosed composition's physical properties, such as causing a polymer to: harden, have an increased melting temperature, etc. Crosslinks may also be formed by chemical reactions under heat, pressure, and/or pH changes. Example crosslinking agents included in compositions described herein include: calcium chloride, calcium phosphate, calcium sulfate, polysaccharides, formaldehyde, glutaraldehyde, dimethyl adipimidate, dimethyl suberimidate, glyoxal, and/or maleic anhydride, a gelling agent, a wax, among others. In some embodiments, wax may also be added to the mixture to provide additional stability to compositions disclosed herein. The wax may include a naturally-derived wax or a synthetic wax.

Compositions described herein can comprise about 0.1%, about 0.2%, about 0.3%, about 0.4%, about 0.5%, about 0.6%, about 0.7%, about 0.8%, about 0.9%, about 1%, about 1%, about 2%, about 3%, about 4%, about 5%, about 6%, about 7%, about 8%, about 9%, about 10%, or more by weight of a cross-linking agent. Compositions described herein can comprise about 0.1 g, about 0.2 g, about 0.3 g, about 0.4 g, about 0.5 g, about 0.6 g, about 0.7 g, about 0.8 g, about 0.9 g, about 1 g, about 1 g, about 2 g, about 3 g, about 4 g, about 5 g, about 6 g, about 7 g, about 8 g, about 9 g, about 10 g, or more of a cross-linking agent.

### Gum

Compositions described herein may comprise gum or a use thereof. The term “gum” as used herein can refer to materials that act as gelling agents, and can comprise, for example, polysaccharides and/or glycoproteins. Gums used in compositions herein include: xanthan gum, acacia gum, gellan gum, guar gum, locust bean gum, tragacanth gum, carrageenan gum, a curdlan gum, a tamarind seed gum, an alginate, a carboxymethylcellulose, a methylcellulose, a microcrystalline cellulose, a locust bean gum, a pectin, curdlan gum, carrageenan, konjac gum, and combinations thereof.

Compositions may comprise 0.01% to about 10% of gum by weight. In some embodiments, compositions disclosed herein comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3% or more a gum by weight.

Compositions may comprise 0.1 g to about 1 g of gum by weight. In some embodiments, compositions disclosed herein comprise about 0.1 g, about 0.2 g, about 0.3 g, about 0.4 g, about 0.5 g, about 0.6 g, about 0.7 g, about 0.8 g, about 0.9 g, about 1 g or more of a gum.

### Lipid

In some embodiments, compositions disclosed herein further comprise one or more lipids of a use thereof. In some embodiments, a composition described herein comprises one or more lipids. In some embodiments, the lipid is a solid lipid, an oil, butter or fat. In some embodiments, compositions disclosed herein can comprise a plant-based lipid, an animal-based lipid, a synthetic lipid, or combinations thereof. In some embodiments, compositions disclosed herein can comprise grapeseed oil, canola oil, sunflower oil, safflower oil, butter, peanut butter, cashew butter, coconut butter, coconut mana, coco butter, soybean oil, coconut oil, corn oil, olive oil, peanut oil, palm oil, oil from beans, such as garbanzo beans or fava beans, and the like. In some embodiments, compositions disclosed herein can comprise avocado oil, grapeseed oil, canola oil, sunflower oil, safflower oil, butter, peanut butter, cashew butter, coconut butter, coconut mana, coco butter, soybean oil, coconut oil, corn oil, olive oil, peanut oil, palm oil, oil from beans, such as garbanzo beans or fava beans, and the like. In some embodiments, compositions disclosed herein can comprise avocado oil.

In some embodiments, a lipid is added to a RuBisCO isolate starter solution described herein. In some embodiments, the lipid is added prior to freezing the RuBisCO isolate starter solution. In some embodiments the lipid is a liquid fat. In some embodiments, the lipid can result in a controlled bundle size of a directionally frozen RuBisCO composition. In some embodiments, the liquid fat comprises: canola oil, avocado oil, corn oil, peanut oil, coconut oil, safflower oil, olive oil, grapeseed oil, sesame oil, hempseed oil, flaxseed oil, sunflower oil, or vegetable oil. In some embodiments, the liquid fat is selected from the group consisting of a: canola oil, avocado oil, corn oil, peanut oil, coconut oil, safflower oil, olive oil, grapeseed oil, sesame oil, hempseed oil, flaxseed oil, sunflower oil, and vegetable oil. In some embodiments, the liquid fat is present in a composition described herein in an amount of about: 0.1%, 0.5%, 1%, 2%, 3%, 4%, 5%, 6%, 7%, 8%, 9%, or 10%. In some embodiments, the liquid fat is present in a composition described herein in an amount of up to: 0.1%, 0.5%, 1%, 2%, 3%, 4%, 5%, 6%, 7%, 8%, 9%, or 10%.

Compositions disclosed herein can comprise about 1%, about 2%, about 3%, about 4%, about 5%, about 7.5%, about 10%, about 15%, about 20%, about 25% or more weight of a lipid. Described herein, “weight” can refer to dry weight or total weight.

Compositions disclosed herein can comprise about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, about 110 g, about 120 g, about 130 g, about 140 g, about 150 g, about 160 g, about 170 g, about 180 g, about 190 g, about 200 g, about 210 g, about 220 g, about 230 g, about 240 g, about 250 g, about 260 g, about 270 g, about 280 g, about 290 g, about 300 g, about 310 g, about 320 g, about 330 g, about 340 g, about 350 g, about 360 g, about 370 g, about 380 g, about 390 g, about 400 g or more of a lipid.

### Coloring Agent

Compositions described herein can comprise one or more coloring agents or a use thereof. The coloring agent may include a natural coloring agent, an artificial dye, and/or another additive that imparts color onto a product.

In some embodiments, compositions can comprise one or more natural coloring agents or artificial coloring agents. In some embodiments, coloring agents included in compositions described herein comprise: carotenoids such as beta-carotene, turmeric, annatto, mango yellow, palm-based oils, or combinations thereof.

In some embodiments, compositions described herein can comprise about 0.01%, about 0.02%, about 0.03%, about 0.04%, about 0.05%, about 0.06%, about 0.07%, about 0.08%, about 0.09%, about 0.1% or more by weight of a coloring agent. In some embodiments, compositions described herein can comprise about 0.01 g, about 0.02 g, about 0.03 g, about 0.04 g, about 0.05 g, about 0.06 g, about 0.07 g, about 0.08 g, about 0.09 g, about 0.1 g, or more of a coloring agent.

### Flavoring Agent

Compositions described herein can comprise one or more flavoring agents or a use thereof. In some embodiments, compositions can comprise one or more natural flavoring agents or artificial flavoring agents, such as salt, spices, such as turmeric, salt, cinnamon, cloves, allspice, ginger, vanilla, vanilla extract, vanilla flavoring, a sugar (e.g., granulated or powdered sugar), tartar, sweeteners, monosodium glutamate, chocolate chips, coco powder, nuts (e.g., pecans) sulfuric flavoring agents, such as black salt, or other flavoring agents, such as a flavor masker. In some embodiments, a sugar is selected from the group consisting of: glucose, ribose, maltodextrin, xylose, arabinose, fructose, mannose, galactose, maltose, lactose, a stereoisomer thereof, and combinations thereof. In some embodiments, one or more flavoring agents mimic the flavor of natural meat, such as beef, pork, bacon, chicken, turkey, veal, rabbit, and the like.

Compositions disclosed herein can comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight of a flavoring agent.

Compositions disclosed herein can comprise about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, about 110 g, about 120 g, about 130 g, about 140 g, about 150 g, about 160 g, about 170 g, about 180 g, about 190 g, about 200 g, about 210 g, about 220 g, about 230 g, about 240 g, about 250 g, about 260 g, about 270 g, about 280 g, about 290 g, about 300 g, about 310 g, about 320 g, about 330 g, about 340 g, about 350 g, about 360 g, about 370 g, about 380 g, about 390 g, about 400 g or more of a flavoring agent.

### Hydrocolloid

Compositions described herein can comprise one or more hydrocolloid agents or a use thereof. A hydrocolloid agent may be used to impart gel-forming properties onto a composition. Examples of the hydrocolloid may include a pectin, a gum, an alginate, a cellulose, an agar, and/or a carrageenan, among other examples not explicitly listed herein.

Compositions described herein can comprise about 0.1%, about 0.2%, about 0.3%, about 0.4%, about 0.5%, about 0.6%, about 0.7%, about 0.8%, about 0.9%, about 1%, about 1%, about 2%, about 3%, about 4%, about 5%, about 6%, about 7%, about 8%, about 9%, about 10%, or more by weight of a hydrocolloid. Compositions described herein can comprise about 0.1 g, about 0.2 g, about 0.3 g, about 0.4 g, about 0.5 g, about 0.6 g, about 0.7 g, about 0.8 g, about 0.9 g, about 1 g, about 1 g, about 2 g, about 3 g, about 4 g, about 5 g, about 6 g, about 7 g, about 8 g, about 9 g, about 10 g, or more of a hydrocolloid.

### Carbohydrate

Examples of the carbohydrate may include: a native starch, a modified starch, a monosaccharide, an oligosaccharide, a soluble fiber, an insoluble fiber and/or a modified fiber, among other examples not explicitly listed herein.

Examples of starches are described herein. Examples of fiber include bran, such as a wheat bran, oat bran, corn bran, rice bran, or other bran, psyllium fiber, citrus fiber, bamboo fiber, carrot fiber, oat fiber, cellulose, methylcellulose, crystalline cellulose, pectin, or any combination thereof.

Compositions described herein can comprise about 0.1%, about 0.2%, about 0.3%, about 0.4%, about 0.5%, about 0.6%, about 0.7%, about 0.8%, about 0.9%, about 1%, about 2%, about 3% or more by weight of a carbohydrate. In some embodiments, compositions described herein can include about 1%, about 2%, about 3%, about 4%, about 5%, about 6%, about 7%, about 8%, about 9%, about 10%, or more by weight of a carbohydrate.

Compositions described herein can comprise about 0.1 g, about 0.2 g, about 0.3 g, about 0.4 g, about 0.5 g, about 0.6 g, about 0.7 g, about 0.8 g, about 0.9 g, about 1 g, about 2 g, about 3 g or more of a carbohydrate. In some embodiments, compositions described herein can include about 0.5-20%, about 1-15%, or about 2-10% by weight of starch, for example, tapioca starch. Compositions described herein can include about 1 g, about 2 g, about 3 g, about 4 g, about 5 g, about 6 g, about 7 g, about 8 g, about 9 g, about 10 g or more of a carbohydrate.

### Fiber

In some embodiments, compositions described herein further include a fiber. In some embodiments, compositions described herein can include bran, such as a wheat bran, oat bran, corn bran, rice bran, or other bran, psyllium fiber, citrus fiber, bamboo fiber, carrot fiber, oat fiber, cellulose, methylcellulose, crystalline cellulose, pectin, or any combination thereof. In some embodiments, fiber used in composition herein, can be micronized into a fine powder. Compositions described herein can comprise about 0.1%, about 0.2%, about 0.3%, about 0.4%, about 0.5%, about 0.6%, about 0.7%, about 0.8%, about 0.9%, about 1%, about 2%, about 3% or more by weight of fiber. Compositions described herein can comprise about 0.1 g, about 0.2 g, about 0.3 g, about 0.4 g, about 0.5 g, about 0.6 g, about 0.7 g, about 0.8 g, about 0.9 g, about 1 g, about 2 g, about 3 g or more of fiber.

### pH Adjusting Agent

Compositions described herein may comprise a pH adjusting agent or a use thereof. In some embodiments, a pH adjusting agent is used to modify the pH of the composition, such as the aqueous solution of the composition. The pH adjusting agent may include an acid, a base, and/or buffer, among other examples not explicitly listed herein.

In some embodiments, compositions herein can comprise one or more salts. The salt may include an organic salt and/or an inorganic salt. The salt may include a soluble salt. Examples of soluble salts include, but are not limited to, calcium lactate gluconate.

In some embodiments, the RuBisCO isolate starter solutions comprise a pH adjusting agent. In some embodiments, the pH adjusting agent is added to the starter solution. In some embodiments, the pH adjusting agent comprises: sodium hydroxide, sodium bicarbonate, sodium carbonate, sodium chloride, citric acid, acetic acid, sodium citrate, lactic acid, ascorbic acid, or a combination of any of these. In some embodiments, the pH adjusting agent is selected from the group consisting of: sodium hydroxide, sodium bicarbonate, sodium carbonate, sodium chloride, citric acid, acetic acid, sodium citrate, lactic acid, ascorbic acid, and a combination of any of these.

Compositions herein can comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7% or more by weight of salts. Compositions herein can comprise about 0.1 g, about 0.2 g, about 0.3 g, about 0.4 g, about 0.5 g, about 0.6 g, about 0.7 g, about 0.8 g, about 0.9 g, about 1 g, about 2 g, about 3 g, about 4 g, about 5 g, about 6 g, about 7 g, about 8 g, about 9 g, about 10 g or more of a salt.

In some embodiments, compositions herein can comprise one or more acids or salts thereof. Examples of acids include, but are not limited to, citric acid and ascorbic acid. Compositions herein can comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1% or more weight of an acid=. Compositions herein can comprise about 0.1 g, about 0.2 g, about 0.3 g, about 0.4 g, about 0.5 g, about 0.6 g, about 0.7 g, about 0.8 g, about 0.9 g, about 1 g, or more of an acid.

In some embodiments, compositions herein can comprise one or more bases or a salt thereof. Examples of bases include, but are not limited to, potassium carbonate, calcium carbonate, or sodium hydroxide. Compositions herein can comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, or about 1% or more by weight of a base. Compositions herein can comprise about 0.1 g, about 0.2 g, about 0.3 g, about 0.4 g, about 0.5 g, about 0.6 g, about 0.7 g, about 0.8 g, about 0.9 g, about 1 g, or more of a base.

Compositions described herein can have a pH of about 4 or less, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, about 6, about 6.1, about 6.2, about 6.3, about 6.4, about 6.5, about 6.6, about 6.7, about 6.8, about 6.9, about 7, about 7.1, about 7.2, about 7.3, about 7.4, about 7.5, about 7.6, about 7.7, about 7.8, about 7.9, about 8, about 8.1, about 8.2, about 8.3, about 8.4, about 8.5, or more. In some embodiments, compositions disclosed herein can have a pH that is similar to the pH of natural meat. Natural meat can have a pH range of about 5.3-7.5.

### Nutrients

Compositions described herein comprise one or more nutrients or a use thereof. In some embodiments, a nutrient may be a macronutrient or a micronutrient.

The macronutrient may include a carbohydrate, a fat, a protein, an essential amino acid, and/or a fatty acid, among other examples not explicitly listed herein. Compositions disclosed herein can include one or more amino acids comprising: alanine, arginine, asparagine, aspartate, cysteine, cystine, histidine, selenocysteine, methionine, isoleucine, leucine, lysine, phenylalanine, threonine, tryptophan, 5-hydroxytryptophan, valine, glutamate, glutamine, glycine, praline, serine, tyrosine. In some embodiments, compositions described herein can comprise one or more amino acids found in natural meat. Examples of amino acids found in meat include histidine, methionine, threonine, tryptophane, valine, leucine, isoleucine, phenylalanine, and lysine. Compositions described herein can comprise one or more amino acids in an amount that is similar to the amount found in a comparable sample unit of meat, or a portion thereof, such as muscle with or without fat.

In some embodiments, the compositions described herein comprise a protein, include one or more proteins comprising: a plant protein described herein, a meat, a protein further comprising heme, a protein further comprising hemoglobin, or a combination of any of these.

The micronutrient may include: calcium, potassium, vitamins, minerals, and/or organic acids, among other examples not explicitly listed herein. Compositions described herein can include one or more nutrients comprising: thiamine, ascorbic acid, L-theanine, acetyl glutathione, riboflavin, pantothenic acid, folic acid, cobalin, vitamin D, vitamin B12, choline, iron, lutein, zeaxanthin, vitamin A, vitamin E, phosphorus, folate, iodine, selenium, zinc, potassium, calcium, or magnesium. In some embodiments, compositions described herein can comprise one or more nutrients in an amount found in a comparable unit of meat or a portion thereof. In some embodiments, the compositions are fortified with nutrients to provide a comparable or improved nutrient profile comparable to natural meat.

### Formulations

In some embodiments, compositions provided herein are formulated using one or more additives. In some embodiments, compositions provided herein are formulated as described herein.

In some embodiments, a composition provided herein comprises a formulation. In some embodiments, the formulation is a food product. In some embodiments, the at least one protein component comprises the RuBisCO protein isolate, which comprises a RuBisCO protein isolate content greater than approximately 80%.

In some embodiments, the at least one protein component is solely the soy protein concentrate. In some embodiments, the at least one protein component comprises a combination of about 90% of the soy protein concentrate and about 10% of the RuBisCO protein isolate. In further examples, the at least one protein component comprises a combination of about 80% of the soy protein concentrate and about 20% of the RuBisCO protein isolate. In further examples, the at least one protein component comprises a combination of about 50% of the soy protein concentrate and about 50% of the RuBisCO protein isolate.

In some embodiments, the at least one protein component is solely the pea protein isolate. In some embodiments, the at least one protein component comprises a combination of about 90% of the pea protein isolate and about 10% of the RuBisCO protein isolate. In some embodiments, the at least one protein component comprises a combination of about 80% of the pea protein isolate and about 20% of the RuBisCO protein isolate. In some embodiments, the at least one protein component comprises a combination of about 50% of the pea protein isolate and about 50% of the RuBisCO protein isolate.

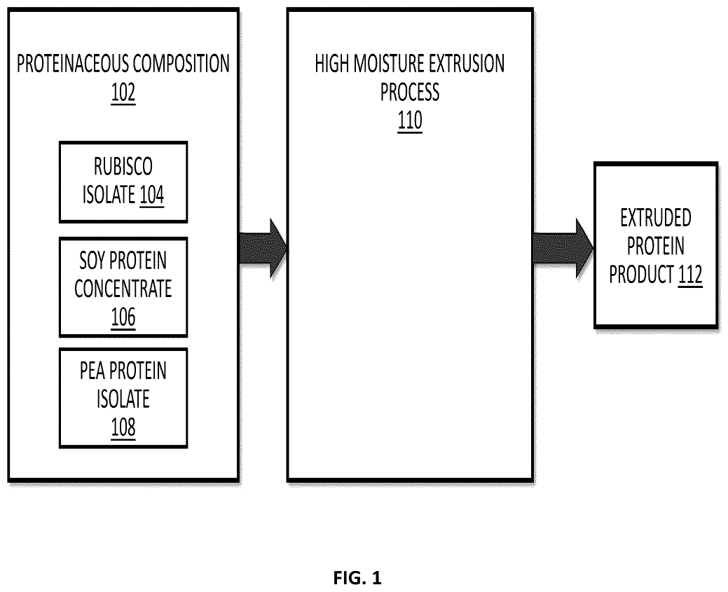

As shown in FIG. 1, and in preferred examples, the protein composition of the proteinaceous composition 102 may include a RuBisCO protein isolate 104, a soy protein concentrate 106, and/or a pea protein isolate 108.

As explained herein, the proteinaceous composition 102 may range from about 15% of the weight of the dry ingredients to about 95% of the weight of the dry ingredients. The amount of protein and/or type of protein in the proteinaceous composition 102 can be modified in order to adjust the protein content or texture of the desired extruded protein product 112. In some examples described herein, the protein content in the proteinaceous composition 102 may be modified to adjust one or more of the following: viscosity, gelling properties, water binding properties, oil binding properties, emulsifying properties, and/or shear properties of the proteinaceous composition 102. In some embodiments, a moisture content of the proteinaceous composition 102 may be at least 25%. It should be appreciated that the moisture content of the proteinaceous composition 102 can be adjusted in order to adjust the moisture content or texture of the extruded protein product 112.

It should be appreciated that the proteinaceous composition 102 described herein may comprise one or more other additives as described herein. The amount and type of additives in a proteinaceous composition 102 can be adjusted in order to adjust a nutritional value, flavor, aroma, color, appearance and/or texture of the extruded protein product 112 produced from the proteinaceous composition 102.

In another embodiment, a high moisture extrudate is described. The high moisture extrudate includes about 40-50 wt. % of a dry blend of components, about 30-60 wt. % of water, and about 0-20 wt. % of a RuBisCO emulsion. The dry blend of components comprises about 70-90 wt. % of a pea protein isolate, about 5-20 wt. % of pea fiber, and about 0-15 wt. % of a RuBisCO protein isolate. Moreover, the RuBisCO emulsion comprises about 5-15 wt. % of a RuBisCO protein isolate, about 35-45 wt. % of the water, about 0-3 wt. % of a flavor, and about 40-50 wt. % of an oil. The high moisture extrudate allows for a high inclusion of the oil without disrupting a fibrous structure formation during cooling and provides an improved fatty mouthfeel perception upon consumption.

In a further embodiment, a directionally frozen highly fibrous scaffold is described. The directionally frozen highly fibrous scaffold is generated from a solution of the RuBisCO protein isolate, an additive, and water.

Without wishing to be bound by theory, a structure or strength of the directionally frozen highly fibrous scaffold of compositions described herein is modulated based on a concentration of the RuBisCO protein isolate. Methods for forming the scaffold and selecting a temperature of for setting of the directionally frozen highly fibrous scaffold and other additives is considered. Moreover, the directionally frozen highly fibrous scaffold may be post-processed to serve as a whole-cut meat product or may be used as a fibrous and protein-rich scaffold for cell culturing to generate a hybrid cultivated meat product.

### Methods

### Preparation of Protein Isolate

Processes disclosed herein separates proteins from other compounds found in plant material. Such processes can be considered as purifying or isolating proteins described herein to obtain protein isolates as described herein. For example, the process may remove chlorophyll, volatilized chemical compounds, acids, bases, sugars, salts, and/or lipids. In some embodiments, the processes disclosed herein reduce the amount of chlorophyll, volatilized chemical compounds, acids, bases, sugars, salts, and/or lipids by 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, or 99% relative to the source plant material.

In some embodiments, the processes disclosed herein remove chlorophyll from plant material, producing protein isolates that are dechlorophyllized. For instance, in some embodiments, the weight ratio of chlorophyll to protein in the protein isolate is less than about 1:1000, 1:1500, 1:2000, or 1:2500. In some embodiments, the processes disclosed herein reduce the amount of chlorophyll by 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, or 99% relative to the source plant material.

In some embodiments, the compositions and processes disclosed herein have decreased or decrease or remove one or more agent(s) that imparts or is associated with one or more organoleptic properties in the purified protein isolates. Non limiting examples of such organoleptic properties include odor (e.g., off-odor or undesirable odor) and taste (e.g., off-taste or undesirable taste). In some embodiments, the compositions and processes disclosed herein have decreased or decrease the one or more agent(s) by 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, or 99% relative to the source plant material. In some embodiments, processes decreased herein can produce odorless, tasteless, or both, compositions. In some embodiments, compositions described herein are odorless, tasteless, or both.

In some embodiments, proteins are extracted from plant material through any known processes. For example, in some instances, plant material containing protein, such as RuBisCO, is homogenized and the protein extracted from the pulp and/or liquid. In some embodiments, the extract can is further clarified, filtered, and washed to arrive at the described protein isolate. In some instances, extraction processes include solvent extraction (e.g., using polar solvents, organic solvents, or supercritical fluids), chromatography (e.g., preparative liquid chromatography), clarification, distillation, filtration (e.g., ultrafiltration), recrystallization, and/or solvent-solvent partitioning.

In one aspect of the disclosure, described herein is a process for making a purified protein isolate from a plant material, comprising the steps of: a) providing the plant material in a solution comprising a reducing agent; b) lysing the plant material; c) separating the lysed plant material into a solid phase and a liquid phase, wherein the liquid phase contains soluble protein and chlorophyll; d) coagulating the chlorophyll in the liquid phase by heating it to a first set temperature in no more than about 30 min, then cooling it to a second set temperature in no more than about 30 min, wherein the cooling is initiated when the liquid phase reaches the first set temperature; e) contacting the liquid phase of d) with a flocculant and/or an adsorbent, and mixing for a period of time sufficient to flocculate and/or adsorb chlorophyll in the liquid phase to the adsorbent, thereby forming a flocculated mixture; f) separating the flocculated mixture of e) into a solid phase and a liquid phase; and g) filtering the liquid phase of f) to yield a filtrate containing a purified protein. In some embodiments, the plant material is harvested and cleaned before the process is started. For instance, in some embodiments, the plant material is chemically washed or washed with water prior to processing. In some embodiments, the plant material is washed more than one time prior to processing.

In some embodiments, the plant material is mixed in a solution comprising a reducing agent. Examples of reducing agents suitable for use in the disclosed processes include, but are not limited to, 2-mercaptoethanol (BME), 2-mercaptoethylamine-HCL, sodium sulfite, magnesium sulfite, sodium metabisulfite, sodium bisulfite, cysteine hydrochloride, dithiothreitol (DTT), glutathione, cysteine, tris(2-carboxyethyl)phosphine (TCEP), ferrous ion, nascent hydrogen, sodium amalgam, oxalic acid, formic acid, magnesium, manganese, phosphorous acid, potassium, sodium, and any combination thereof. Said solution may comprise other components to provide beneficial properties to the solution or to the process. Examples such components include buffering agents, chelating agents, protease inhibitors, pH adjustors, and the like.

In some embodiments, lysing is conducted through any suitable method to disrupt plant material and release cellular contents, such as a plant cell's cytoplasm. Types of lysing described herein include mechanical, chemical, and/or enzymatic lysis. Mechanical lysing encompassed by the processes described herein includes, but is not limited to, mechanical agitation, pressure, grinding, squeezing, shearing, using a blender, using a mill, using a press, a sonicator, a nitrogen burst, ultrasonic energy, by freezing, using a homogenizer, a pulse electric field, a disintegrator, more than one of the foregoing, or any combination thereof. Chemically lysing encompassed by the processes described herein includes, but is not limited to, lysed chemically using one or more of detergents (e.g., ionic, cationic, anionic, sodium dodecyl sulfates, non-ionic, zwitterionic, hypotonic, hypertonic, and isotonic detergents and the like). Chemically lysing encompassed by the processes described herein includes, but is not limited to, using one or more enzymes, such as cellulase and/or pectinase.

Separation of the lysed plant material and/or flocculated mixture into solid phase and a liquid phase may be performed by any suitable solid-liquid separation technique. Suitable solid-liquid separation techniques include but are not limited to: gravity settling, sieving (e.g., circular vibratory separator or a linear/inclined motion shaker), filtration (e.g, dead-end filtration system, using ultrafiltration, using a tangential flow filtration system, or using a plate filter), centrifugation (e.g., disk stack centrifuge, a decanter centrifuge, a continuous centrifuge, or a basket centrifuge), a press (e.g., screw press, a French press, a belt press, a filter press, a fan press, a finisher press, or a rotary press), or decanting (e.g., using a decantor), or any combination thereof.

The process for making the protein isolates described herein can also comprise a step of coagulating components that are undesired (e.g., components that are not protein, such as RuBisCO) using any suitable method to effect coagulation. Examples include, but are not limited to: heat treatment, cooling; addition of one or more salts (e.g., a calcium salt, a magnesium salt, a beryllium salt, a zinc salt, a cadmium salt, a copper salt, an iron salt, a cobalt salt, a tin salt, a strontium salt, a barium salt, a radium salt, calcium chloride, calcium nitrate, or iron carbonate potassium phosphate, calcium chloride, or any combination thereof); addition of quaternary ammonia specie; addition of a polymer based coagulate; electrocoagulation; and the like.

The process for making the protein preparation may also comprise a step of contacting the liquid phase with a flocculant and/or an adsorbent and mixing for a period of time sufficient to flocculate and/or adsorb chlorophyll in the liquid phase to the adsorbent, thereby forming a flocculated mixture. Any suitable process of flocculation can be used and exemplary flocculants may include, but are not limited to, an alkylamine epichlorohydrin, polydimethyldiallylammonium chloride, a polysaccharide (e.g., chitosan), a polyamine, starch, aluminum sulphate, alum, polyacrylamide, polyacrylamide, or polyethyleneimine. Any suitable adsorbent can be used and exemplary adsorbents may include activated carbon, graphite, silica gel, zeolites, clay, polyethylene, and resins (e.g., ion-exchange resins, size exclusion chromatography (SEC) resins, affinity based resins, or hydrophobicity based resin).

After the separation of the flocculated mixture into a solid phase and a liquid phase, the liquid phase may be filtered to yield a filtrate containing the purified protein. Any suitable method of filtration can be used and include, for example, the use of surface filters, depth filters, by membrane filtration, column filtration, diafiltration, ultrafiltration, tangential flow filtration, filtration with diatomaceous earth, filtration with silt, filtration with activated carbon, and the like.

Liquid phases and/or filtrates can be further sterilized, concentrated, dialyzed, dried, and/or otherwise processed to provide protein isolates for use herein. In some embodiments, liquid phases and/or filtrates may be dried. In some embodiments, drying may be accomplished using a spray dryer, a freeze dryer, drum drying, film drying, bed drying, a flash dryer, or a rotary dryer.

In some embodiments, the purity of protein isolates described herein is at least about 30%, 40%, 50%, 60%, 70%, 80%, 90%, 95%, or more. In some embodiments, the purity of protein isolate described herein is 80% or more. In certain embodiments, protein isolates described herein may contain no more than 50%, 40%, 30%, 20% 10% or less impurities. In certain embodiments, protein isolates described herein may contain no more than 20% 10% or less impurities. In some embodiments, processes described herein produce one or more by-products, such as sodium hydroxide.

### Extrusion of Protein Isolate Preparations

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As discussed, recent developments in extrusion technologies have allowed for the production of extruded protein products made from animal derived and/or non-animal derived protein sources that have oriented fibers that are texturally similar to meat. Although taste and texture of such extruded protein products is approaching that of meat, thus far the rate of production has been limited.

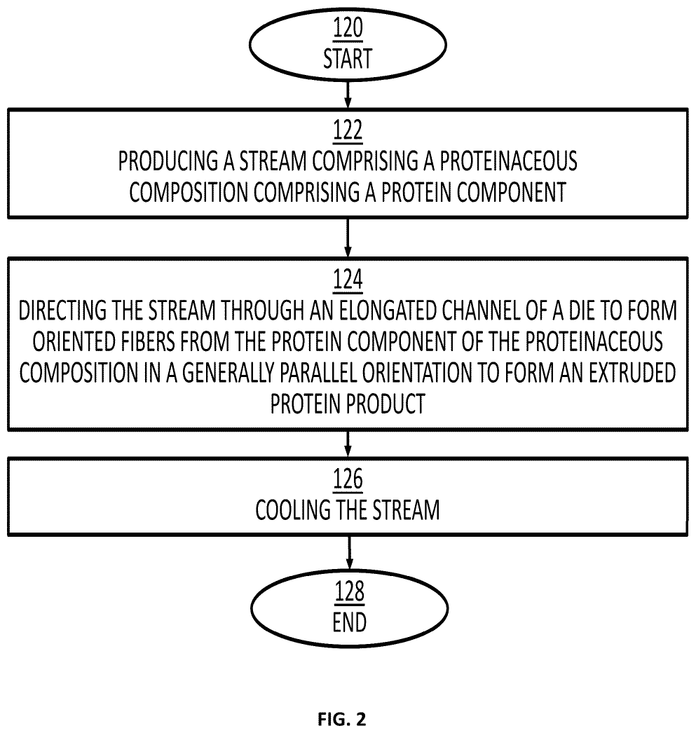

The disclosure also provides a method for making an extruded protein product (e.g., an extruded protein product 112 of FIG. 1) using a high-moisture extrusion technique or process 110 (of FIG. 1). The method can include numerous process steps, as shown in FIG. 2. For example, the method of FIG. 2 begins at a process step 120. A process step 122 follows the process step 120 and includes producing a stream comprising a proteinaceous composition 102 (of FIG. 1). The proteinaceous composition 102 includes a protein component that can form oriented fibers.

It should be appreciated that the stream comprising the proteinaceous composition 102 of the process step 122 of FIG. 2 can be produced using any appropriate method and equipment known to those having ordinary skill in the art. For example, in some embodiments, the stream can be produced using an extruder, such as a single screw, twin, or triple screw extruder, or a ring extruder. In some implementations, the temperature and/or viscosity of the stream may be optionally modified to adjust flow behavior, flow balance, or other stream properties, such as melting of protein in the extruder, and/or cooling, gelling, setting, and/or structure formation in the die.

In some embodiments, the stream comprising the proteinaceous composition 102 can be optionally directed through a transition apparatus (not shown) after exiting the extruder and before entering the die (of a process step 124 of FIG. 2). The transition apparatus may include a means (e.g., a breaker plate, a series of baffles, or a laminar flow static mixer, among others) to pre-align fibers of the stream in order to facilitate texturization.

In some embodiments, the transition apparatus may include an additive port that is configured to receive an additive to the proteinaceous composition 102 prior to entering a longitudinal channel of the die (of the process step 124 of FIG. 2). Examples of the additive are described herein.

The process step 124 follows the process step 122 in FIG. 2 and includes directing the stream through an elongated channel of the die to form oriented fibers from the protein component of the proteinaceous composition 102 in a generally parallel orientation to form the extruded protein product 112. A process step 126 follows the process step 124 in FIG. 2 and includes cooling the stream. In some embodiments, the die includes a cooling apparatus or may utilize a cooling liquid. In some embodiments, a portion of the die may be passed through a refrigerated chamber to cool the stream. A process step 128 follows the process step 126 and concludes the method of FIG. 2.

Optionally, the method may include directing the stream through a transition apparatus after exiting the extruder and before entering a die. The transition apparatus may include an additive port through which one or more additive, as described herein, may be added to the proteinaceous composition.

Next, the method includes directing the stream through an elongated channel of the die to form the oriented fibers from the at least one protein component in a generally parallel orientation to form an extruded protein product. In some embodiments, the method may optionally include: modifying a temperature and/or a viscosity of the stream to adjust a property of the stream, such as a flow behavior of the stream and/or a flow balance of the stream.

Further, the method may include: cooling the stream to provide the oriented fibers throughout a thickness of the extruded protein product. In examples, the cooling of the stream may occur via a cooling apparatus, a cooling liquid, and/or a refrigerated chamber, among other examples not explicitly listed herein.

Preparation of Meat Compositions using Directional Freezing

### RuBisCO Solutions for Directional Freezing

In some embodiments, a RuBisCO protein isolate meat composition described herein is prepared using a directionally frozen RuBisCO protein isolate meat composition precursor. In some embodiments, the RuBisCO protein isolate meat composition precursor is directionally frozen, and then subsequently heated to set the uniformity of the composition. In some embodiments, a RuBisCO protein isolate meat composition is a food product. In some embodiments, a RuBisCO protein isolate meat composition is a meat food product. In some embodiments the RuBisCO protein isolate meat composition food product is a rehydrated composition from the heated RuBisCO protein isolate meat composition that previously underwent directional Freezing. In some embodiments, the RuBisCO protein isolate meat composition food product is referred to herein as a “food product,” or a “rehydrated food product.” In some embodiments, the food product is rehydrated from a food product precursor described herein. In some embodiments, the food product is rehydrated from a food product precursor for about: 1, 2, 3, 4, 5, 6, 7, 8, 9, 10, 12, 15, 18, 20, 24, 36, 48, 56, or 72 hours. In some embodiments, the food product has a water weight percent of about: 10, 20, 30, 40, 50, 60, 70, 80, 90, or 95 percent. In some embodiments, the food product has a water weight percent of about: 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 percent. In some embodiments, preparation of a RuBisCO protein isolate meat composition precursor comprises a heated directionally frozen RuBisCO protein isolate composition. In some embodiments, RuBisCO protein isolate is directionally frozen. In some embodiments, solutions comprising RuBisCO protein isolate are prepared in water as aqueous solutions comprising RuBisCO protein isolate. In some embodiments, the aqueous solution comprises an additive. In some embodiments, the aqueous solution comprises at least one additive. In some embodiments, the aqueous solution comprises multiple additives. In some embodiments, the additive comprises a: salt, a lipid, a liquid fat, a gum, multiple salts, a starch, a polysaccharide, a flavoring agent, or a coloring agent. In some embodiments, the additive is selected from the group consisting of a: salt, a lipid, a liquid fat, a gum, multiple salts, a starch, a polysaccharide, a flavoring agent, and a coloring agent. In some embodiments, the additive comprises agar, carrageenan, gellan gum, alginate, curdlan gum, pectin, guar gum, xanthan gum, konjac gum, tamarind seed gum, and cysteine. In some embodiments, the aqueous solution comprises one additive. In some embodiments, the aqueous solution comprises multiple additives. In some embodiments, has an independent weight percent from about: 0-10 weight percent. The effect of these additives on the meat can reduce the fiber diameter and increase the hardness of the meat product. In some embodiments, the additive is hydrated at elevated temperatures. In some embodiments, the additive is hydrated at elevated temperatures followed by cooling prior to the addition of the RuBisCO protein isolate into the aqueous solution. In some embodiments, the additive is dispersed at room temperature into the aqueous solution prior to the addition of the RuBisCO protein isolate into the aqueous solution. An additive described herein is combined with a crosslinking agent. In some embodiments, the crosslinking agent is epigallocatechin gallate. In some embodiments, epigallocatechin gallate crosslinking agent is used in conjunction with a tamarind seed extract. and calcium ions form any source in conjunction with an alginate. The calcium ion may also be delivered after the freeze step in the form of an external bath. In some embodiments, the additive is a gelling agent. In some embodiments, the gelling agent comprises: agar, curdlan, K-carrageenan, gellan, or sodium alginate with calcium chloride. In some embodiments, the gelling agent in the aqueous solution is in an amount of up to: 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 3.0, 4.0, 5.0, 6.0, 7.0, 8.0, 9.0, 10.0, 11.0, 12.0, 13.0, 14.0, or 15.0 percent weight. In some embodiments, the additive is an agar. In some embodiments, the agar is present in an aqueous solution described herein in an amount of up to: In some embodiments, the aqueous solution comprises at least one additive. In some embodiments, the aqueous solution comprises at least two additives. In some embodiments, the aqueous solution comprises multiple additives. In some embodiments, the aqueous solution comprises a plant-based protein. In some embodiments, the aqueous solution comprises at least one plant-based protein. In some embodiments, the aqueous solution comprises at least two plant-based proteins. In some embodiments, the aqueous solution comprises multiple plant-based proteins. In some embodiments, the aqueous solution comprises RuBisCO protein isolate, and a second plant-based protein described herein. In some embodiments, the RuBisCO protein isolate is an amount of 15 percent weight. In some embodiments, the plant-based protein comprises a: fava protein, a rice protein, a pea protein, or a mung bean protein. In some embodiments, the plant-based protein is selected from the group consisting of a: fava protein, a rice protein, a pea protein, and a mung bean protein. In some embodiments, the aqueous solutions comprise about: 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 weight percent RuBisCO protein isolate.

### Analytical Methods for Evaluating RuBisCO Meat Compositions and RuBisCO Meat Precursors Prepared by a Directional Freezing Method

### Directional Freezing Bundle Analyses

In some embodiments, the directionally frozen RuBisCO protein isolate meat composition precursors, referred to herein as food product precursors, are examined for visual qualitative representation. In some embodiments, a stereoscope is used to evaluate directionally frozen RuBisCO protein isolate meat composition precursors. In some instances, bundle size, measured in millimeters (mm) is quantitatively measured using a stereoscope.

### Texture and Harness Analyses

In some embodiments, a texture analyzer is used to assess texture of rehydrated meat composition samples described herein. In some embodiments, texture analysis is conducted after a meat composition scaffold is dried at an increased temperature. In some embodiments, a Multi-Test-I Single-column texture analyzer is used for texture analysis. In some embodiments, texture analyses include compression of rehydrated meat composition samples. Texture analysis can provide an indication of the hardness of a meat composition. The force required to compress a meat composition described herein is calculated as a function of time. Texture analysis can further provide an indication of the cohesiveness of a meat composition. In some embodiments, the meat composition is referred to herein as a RuBisCO isolate meat food product, or referred to herein as a food product. In some embodiments, the hardness is measured in Newtons (N). In some embodiments, the hardness of a food product described herein is about: 1, 2, 3, 4, 5, 10, 15, 20, 25, 30, 35, 40, 45, 50, 55, 60, 65, 70, 75, 80, 85, or up to 90 N.

In some embodiments, the cohesiveness of a food product is measured. In some embodiments, cohesiveness is measured as a percent compression of a food product. In some embodiments the compression of a food product described herein is about: 5%, 10%, 20%, 25%, 30%, 35%, 40%, 45%, 50%, 55%, 60% 65%, or up to 70% compression.

### Further Embodiments

In some embodiments, provided herein are methods of heating compositions, the methods comprising: heating a composition comprising a frozen ribulose-1,5-bisphosphate carboxylase/oxygenase (RuBisCO) protein isolate to generate a heated RuBisCO composition comprising a substantially unidirectional morphology and a generally uniform structure in a solid form, wherein the substantially unidirectional morphology comprises a macroscopic fibrous structure comprising interconnected vertical bundles of the heated RuBisCO composition. In some embodiments, the heating partially dehydrates the heated RuBisCO composition. In some embodiments, the heating dehydrates the heated RuBisCO composition. In some embodiments, the heating of the composition generates a heated RuBisCO composition that is a food product precursor. In some embodiments, the heating results in the macroscopic fibrous structure remaining unchanged at room temperature. In some embodiments, the substantially unidirectional morphology comprises interconnected vertical bundles having an average diameter of 0.1 to 0.8 millimeters. In some embodiments, the method further comprises rehydrating the heated RuBisCO composition. In some embodiments, the rehydrating thereby generates a food product. In some embodiments, the composition further comprises animal meat or an animal meat component. In some embodiments, the composition further comprises a fiber, a starch, and/or a lecithin. In some embodiments, the animal meat component comprises heme or hemoglobin. In some embodiments, the composition further comprises an additive, a flavoring agent, or a coloring agent. In some embodiments, the RuBisCO protein isolate is free of chlorophyll. In some embodiments, the RuBisCO protein isolate is flavorless and colorless. In some embodiments, the RuBisCO protein isolate comprises a large subunit and a small subunit of RuBisCO protein. In some embodiments, the RuBisCO protein isolate comprises protein comprising a sequence at least 90% identical to any one of SEQ ID NO: 1 to SEQ ID NO: 10. In some embodiments, the RuBisCO protein isolate comprises protein comprising a sequence at least 95% identical to any one of SEQ ID NO: 1 to SEQ ID NO: 10. In some embodiments, the RuBisCO protein isolate comprises protein comprising a sequence of SEQ ID NO: 1 or 2; SEQ ID NO: 3 or 4; SEQ ID NO: 5 or 6; SEQ ID NO: 7 or 8; or SEQ ID NO: 9 or 10. In some embodiments, the RuBisCO protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10. In some embodiments, the RuBisCO protein isolate comprises a RuBisCO protein large subunit. In some embodiments, the RuBisCO protein isolate comprises a RuBisCO protein small subunit. In some embodiments, the RuBisCO protein isolate is from a plant in the Lemna genus. In some embodiments, the RuBisCO protein isolate is from a Lemna minor. In some embodiments, the RuBisCO protein isolate is from a Lemna aequinoctialis, Lemna disperma, Lemna ecuadoriensis, Lemna gibba, Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris.

In some embodiments, provided herein are methods of preparing a structured food product precursor comprising: providing a composition comprising a ribulose-1,5-bisphosphate carboxylase/oxygenase (RuBisCO) protein isolate from a plant and a solvent; freezing the composition to form a frozen composition; dehydrating the composition to form a frozen, dehydrated composition; and heating the frozen composition to form a structured food product precursor, wherein the structured food product precursor has a macroscopic fibrous structure. In some embodiments, the heating is above 100 degrees Celsius for at least 1 hour. In some embodiments, the methods further comprise rehydrating the structured food product precursor. In some embodiments, the heating is at 120 degrees Celsius for 2 hours. In some embodiments, the composition further comprises animal meat or an animal meat component. In some embodiments, the animal meat component comprises heme or hemoglobin. In some embodiments, the composition further comprises a fiber, a starch, and/or a lecithin. In some embodiments, the methods further comprise freeze drying to dehydrate the composition. In some embodiments, the dehydrating comprises solvent removed via freeze drying. In some embodiments, the dehydrating further comprises the use of a solvent replacement bath.

In some embodiments, the dehydrating further comprises the use of a solvent replacement bath. In some embodiments, a unidirectionally frozen RuBisCO composition is dehydrated using a solvent replacement bath. In some embodiments, the solvent replacement bath comprises a solution. In some embodiments, the solvent replacement bath comprises a solvent. In some embodiments, the solvent comprises ethylene glycol, ethanol, isopropyl alcohol, acetone, ethyl acetate, methanol, water, or a combination of any of these. In some embodiments, the solvent replacement bath comprises acetone. In some embodiments, the solvent replacement bath comprises ethanol. In some embodiments, the solvent replacement bath comprises a solvent content of about: 5, 10, 15, 20, 25, 30, 35, 40, 45, 50, 55, 60, 65, 70, 75, 80, 85, 90, 95, 99, or 100 percent. In some embodiments, the solvent replacement bath comprises a solvent content of up to: 5, 10, 15, 20, 25, 30, 35, 40, 45, 50, 55, 60, 65, 70, 75, 80, 85, 90, 95, 99, or 100 percent. In some embodiments, the solvent replacement bath comprises an ethanol content of about: 5, 10, 15, 20, 25, 30, 35, 40, 45, 50, 55, 60, 65, 70, 75, 80, 85, 90, 95, 99, or 100 percent. In some embodiments, the solvent replacement bath comprises an ethanol content of up to: 5, 10, 15, 20, 25, 30, 35, 40, 45, 50, 55, 60, 65, 70, 75, 80, 85, 90, 95, 99, or 100 percent. In some embodiments, the solvent replacement bath comprises an acetone content of about: 5, 10, 15, 20, 25, 30, 35, 40, 45, 50, 55, 60, 65, 70, 75, 80, 85, 90, 95, 99, or 100 percent. In some embodiments, the solvent replacement bath comprises an acetone content of up to: 5, 10, 15, 20, 25, 30, 35, 40, 45, 50, 55, 60, 65, 70, 75, 80, 85, 90, 95, 99, or 100 percent. In some embodiments, the solvent replacement bath comprises a solvent and water. In some embodiments, the solvent is an organic solvent. In some embodiments, the solvent replacement bath comprises an organic solvent and water. In some embodiments, the solvent replacement bath comprises an organic solvent and water, wherein the organic solvent comprises about: 10, 15, 20, 25, 30, 35, 40, 45, 50, 55, 60, 65, 70, 75, 80, 85, 90, or 95 percent of the solvent replacement bath. In some embodiments, the solvent replacement bath comprises ethanol and water. In some embodiments, the solvent replacement bath comprises ethanol and water, wherein the ethanol comprises about: 10, 15, 20, 25, 30, 35, 40, 45, 50, 55, 60, 65, 70, 75, 80, 85, 90, or 95 percent of the solvent replacement bath. In some embodiments, the solvent replacement bath comprises methanol and water. In some embodiments, the solvent replacement bath comprises methanol and water, wherein the methanol comprises about: 10, 15, 20, 25, 30, 35, 40, 45, 50, 55, 60, 65, 70, 75, 80, 85, 90, or 95 percent of the solvent replacement bath. In some embodiments, the solvent replacement bath comprises acetone and water. In some embodiments, the solvent replacement bath comprises isopropyl alcohol and water. In some embodiments, the solvent replacement bath comprises ethylene glycol and water. In some embodiments, the solvent replacement bath comprises a water content of about: 5, 10, 15, 20, 25, 30, 35, 40, 45, 50, 55, 60, 65, 70, 75, 80, 85, 90, 95, 99, or 100 percent. In some embodiments, the solvent replacement bath comprises a water content of up to: 5, 10, 15, 20, 25, 30, 35, 40, 45, 50, 55, 60, 65, 70, 75, 80, 85, 90, 95, 99, or 100 percent. In some embodiments, the solvent replacement bath has a pH of at least: 2, 3, 4, 5, 6, 7, 8, 9, or 10. In some embodiments, the solvent replacement bath has a pH of about: 2, 3, 4, 5, 6, 7, 8, 9, or 10. In some embodiments, the solvent replacement bath comprises a salt. In some embodiments, the salt is a non-toxic salt. In some embodiments, the solvent replacement bath comprises about: 0, 1, 2, 3, 4, 5, 6, 7, 8, 9, 10, 11, 12, 13, 14, 15, 16, 17, 18, 19, or 20 weight percent of a salt. In some embodiments, the solvent replacement bath comprises sodium chloride. In some embodiments, the solvent replacement bath comprises about: 0, 1, 2, 3, 4, 5, 6, 7, 8, 9, 10, 11, 12, 13, 14, 15, 16, 17, 18, 19, or 20 weight percent of sodium chloride. In some embodiments, the solvent replacement bath comprises calcium chloride. In some embodiments, the solvent replacement bath comprises about: 0, 1, 2, 3, 4, 5, 6, 7, 8, 9, 10, 11, 12, 13, 14, 15, 16, 17, 18, 19, or 20 weight percent of calcium chloride. In some embodiments, the solvent replacement bath comprises an additive and a salt. In some embodiments, the additive is a gum. In some embodiments, the additive is an alginate. In some embodiments, the additive is sodium alginate. In some embodiments, the solvent replacement bath comprises ammonium sulfate. In some embodiments, the solvent replacement bath comprises about: 0, 1, 2, 3, 4, 5, 6, 7, 8, 9, 10, 11, 12, 13, 14, 15, 16, 17, 18, 19, or 20 weight percent of ammonium sulfate.

In some embodiments are methods for dehydrating a unidirectionally frozen RuBisCO using a solvent replacement bath. In some embodiments, the solvent replacement bath comprises a solution described herein. In some embodiments, the solvent replacement bath has a temperature of about: −80, −75, −70, −65, −60, −55, −50, −45, −40, −35, −30, −25, −20, −15, −10, −9, −8, −7, −6, −5, 0, 5, 10, 15, 20, 25, or 30 degrees Celsius. In some embodiments, the solvent replacement bath has a temperature of about −8 degrees Celsius

In some embodiments, the freeze-drying results in a dehydrated unidirectionally frozen RuBisCO composition. In some embodiments, the heating results setting a macroscopic fibrous structure.

In some embodiments, provided herein are methods of preparing a composition, the methods comprising: providing a composition comprising: a ribulose-1,5-bisphosphate carboxylase/oxygenase (RuBisCO) protein isolate from a plant and a solvent; freezing the composition to form a frozen composition; exposing the composition to a freeze-dryer replacement bath, thereby generating a frozen composition; and heating the dehydrated frozen composition to form a food product precursor, wherein the structured plant protein food precursor product has a macroscopic fibrous structure. In some embodiments, the RuBisCO composition is incubated for 24 hours in the freeze dryer replacement bath. In some embodiments, the freeze drier replacement bath comprises an organic solvent, water, a salt, and a buffer. In some embodiments, the method thereby generates the RuBisCO composition that is substantially dry. In some embodiments, the freeze drying comprises the use of the freeze-dryer replacement bath comprising a metal container, and wherein the metal container comprises a conductive material. In some embodiments, the freeze drying comprises the use of the freeze-dryer replacement bath comprising a metal selected from the group consisting of: copper and steel. In some embodiments, the freeze drying further comprises sublimation of the composition. In some embodiments, the methods further comprise incubating the composition for at least 24 hours with a water miscible solvent, water, salt, and a buffer. In some embodiments, the composition further comprises a fiber, a starch, and/or a lecithin.

In some embodiments, provided herein are compositions, wherein the compositions comprise: a ribulose-1,5-bisphosphate carboxylase/oxygenase (RuBisCO) protein isolate; a solvent; and an additive, wherein when a portion of the composition is subjected to uniform geometry analysis, the portion comprises a 38 mm diameter and a height of 15 mm, wherein the portion comprises a hardness of 10 to 70 Newtons (N) when hardness is measured by a first compression event using a Mecmesin MultiTest 2.51 device, and/or wherein the food product has a cohesiveness of 20 to 60 percent when measured by calculating the area under the second compression cycle divided by the area under the first compression cycle using a Mecmesin MultiTest 2.5 device. In some embodiments, the RuBisCO protein isolate is present in an amount of 2-50% by weight, optionally 2-30% by weight. In some embodiments, the RuBisCO protein isolate is present in an amount of up to about 50% by weight. In some embodiments, the RuBisCO protein isolate is present in an amount of 40% to 50% by weight. In some embodiments, the solvent comprises water. In some embodiments, the solvent comprises water and an organic solvent. In some embodiments, the solvent is selected from the group consisting of water, an alcohol, and acetone. In some embodiments, the composition comprises a buffer. In some embodiments, the composition comprises a salt. In some embodiments, the composition comprises a starch. In some embodiments, the composition comprises a fat replacement agent. In some embodiments, the composition comprises a dye. In some embodiments, the composition comprises a flavoring agent. In some embodiments, the composition comprises a gelling agent. In some embodiments, the composition comprises a preservative. In some embodiments, the composition further comprises a fiber, a starch, and/or a lecithin. In some embodiments, the composition further comprises an additional protein or protein isolate. In some embodiments, the additional protein or protein isolate is plant-based. In some embodiments, the additional protein or protein isolate is an animal protein or animal protein isolate. In some embodiments, the composition comprises a lipid. In some embodiments, the lipid is a liquid fat. In some embodiments, the composition is a food product. In some embodiments, the food product is a meat. In some embodiments, the RuBisCO protein isolate is free of chlorophyll. In some embodiments, the RuBisCO protein isolate is flavorless and colorless. In some embodiments, the RuBisCO protein isolate comprises a large subunit and a small subunit of RuBisCO protein. In some embodiments, the RuBisCO protein isolate comprises protein comprising a sequence at least 90% identical to any one of SEQ ID NO: 1 to SEQ ID NO: 10. In some embodiments, the RuBisCO protein isolate comprises protein comprising a sequence at least 95% identical to any one of SEQ ID NO: 1 to SEQ ID NO: 10. In some embodiments, the RuBisCO protein isolate comprises protein comprising a sequence of SEQ ID NO: 1 or 2; SEQ ID NO: 3 or 4; SEQ ID NO: 5 or 6; SEQ ID NO: 7 or 8; or SEQ ID NO: 9 or 10. In some embodiments, the RuBisCO protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10. In some embodiments, the RuBisCO protein isolate comprises a RuBisCO protein large subunit. In some embodiments, the RuBisCO protein isolate comprises a RuBisCO protein small subunit. In some embodiments, the RuBisCO protein isolate is from a plant in the Lemna genus. In some embodiments, the RuBisCO protein isolate is from a Lemna minor In some embodiments, the RuBisCO protein isolate is from a Lemna aequinoctialis, Lemna disperma, Lemna ecuadoriensis, Lemna gibba, Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris. In some embodiments, the food product is a raw meat.

Provided here are compositions in a solid form comprising at least one region of unidirectional morphology, i.e., substantially parallel morphology. In some embodiments, the composition further comprises a RuBisCO protein isolate and the unidirectional morphology comprises interconnected vertical bundles of the RuBisCO protein isolate. Directionality as used herein (directional or unidirectional, or directionally or unidirectionally), refers to a material morphology that is substantially parallel. In some embodiments, the composition is partially dehydrated. In some embodiments, the composition is dehydrated. In some embodiments, the composition is a food product precursor. In some embodiments, the food product precursor is a hydrate. In some embodiments, the interconnected vertical bundles have an average diameter of 0.1 to 0.8 millimeters. In some embodiments, the composition comprises a macroscopic fibrous structure. In some embodiments, the food product comprises a macroscopic fibrous structure. In some embodiments, the bundles comprised in the macroscopic fibrous structure are observable without magnification. In some embodiments, the RuBisCO composition is not a free-flowing powder. In some embodiments, the composition comprises a macroscopic fibrous structure. In some embodiments, the food product comprises a macroscopic fibrous structure. In some embodiments, the bundles comprised in the macroscopic fibrous structure are observable without magnification. In some embodiments, the frozen RuBisCO is not a free-flowing powder. In some embodiments, the composition further comprises an additive, a flavoring agent, or a coloring agent. In some embodiments, the composition further comprises a fiber, a starch, and/or a lecithin. In some embodiments, the RuBisCO protein isolate is free of chlorophyll. In some embodiments, the RuBisCO protein isolate is flavorless and colorless. In some embodiments, the RuBisCO protein isolate comprises a large subunit and a small subunit of RuBisCO protein. In some embodiments, the RuBisCO protein isolate comprises protein comprising a sequence at least 90% identical to any one of SEQ ID NO: 1 to SEQ ID NO: 10. In some embodiments, the RuBisCO protein isolate comprises protein comprising a sequence at least 95% identical to any one of SEQ ID NO: 1 to SEQ ID NO: 10. In some embodiments, the RuBisCO protein isolate comprises protein comprising a sequence of SEQ ID NO: 1 or 2; SEQ ID NO: 3 or 4; SEQ ID NO: 5 or 6; SEQ ID NO: 7 or 8; or SEQ ID NO: 9 or 10. In some embodiments, the RuBisCO protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10. In some embodiments, the RuBisCO protein isolate comprises a RuBisCO protein large subunit. In some embodiments, the RuBisCO protein isolate comprises a RuBisCO protein small subunit. In some embodiments, the RuBisCO protein isolate is from a plant in the Lemna genus. In some embodiments, the RuBisCO protein isolate is from a Lemna minor In some embodiments, the RuBisCO protein isolate is from a Lemna aequinoctialis, Lemna disperma, Lemna ecuadoriensis, Lemna gibba, Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris.

In some embodiments, provided herein is a method of preparing a rehydrated RuBisCO composition, the method comprising exposing a baked RuBisCO composition to a second composition comprising water, oil, a flavoring agent, a pH control, a salt, or a fat substitute at a temperature of 4-95 degrees Celsius for 1 minute to 48 hours. In some embodiments, the preparing of the rehydrated RuBisCO composition generates a food product having a cohesiveness of 25 to 75%. In some embodiments, the preparing of the rehydrated RuBisCO composition generates a food product having a hardness of 10 to 70 Newtons. In some embodiments, the rehydrated RuBisCO composition further comprises a fiber, a starch, and/or a lecithin.

In some embodiments, provided herein are methods for making an extruded protein product using a high-moisture extrusion technique, the method comprising: producing a stream comprising a proteinaceous composition, wherein the proteinaceous composition comprises at least one protein component capable of forming oriented fibers; directing the stream through an elongated channel of a die to form the oriented fibers from the at least one protein component in a generally parallel orientation to form an extruded protein product; and cooling the stream to provide the oriented fibers throughout a thickness of the extruded protein product. In some embodiments, proteinaceous compositions further comprises water. In some embodiments, the at least one protein component is selected from the group consisting of: a ribulose 1,5-bisphosphate (RuBP) carboxylase/oxygenase (RuBisCO) protein isolate, a soy protein concentrate, and a pea protein isolate. In some embodiments, the at least one protein component comprises the soy protein concentrate. In some embodiments, the at least one protein component comprises about 90% of the soy protein concentrate and about 10% of the RuBisCO protein isolate. In some embodiments, the at least one protein component comprises about 80% of the soy protein concentrate and about 20% of the RuBisCO protein isolate. In some embodiments, the at least one protein component comprises the pea protein isolate. In some embodiments, the at least one protein component comprises about 90% of the pea protein isolate and about 10% of the RuBisCO protein isolate. In some embodiments, the at least one protein component comprises about 80% of the pea protein isolate and about 20% of the RuBisCO protein isolate. In some embodiments, the at least one protein component comprises about 50% of the pea protein isolate and about 50% of the RuBisCO protein isolate. In some embodiments, the at RuBisCO protein isolate comprises a protein content greater than approximately 80%. In some embodiments, the RuBisCO protein isolate is free of chlorophyll. In some embodiments, the RuBisCO protein isolate is flavorless and colorless. In some embodiments, the RuBisCO protein isolate is extracted from a photosynthesizing plant or a photosynthesizing organism. In some embodiments, the stream is produced using an extruder. In some embodiments, the extruder is selected from the group consisting of: a single screw extruder, a twin extruder, a triple screw extruder, and a ring extruder. In some embodiments, methods provided herein further comprise: modifying a temperature and/or a viscosity of the stream to adjust a flow behavior of the stream and/or a flow balance of the stream. In some embodiments, the cooling of the stream occurs via a cooling apparatus, a cooling liquid, and/or a refrigerated chamber. In some embodiments, methods provided herein further comprise: directing the stream through a transition apparatus after exiting an extruder and before entering the die, wherein the transition apparatus comprises an additive port, and wherein the additive port receives an additive to the proteinaceous composition. In some embodiments, the additive is selected from the group consisting of: a lipid, a coloring agent, a hydrocolloid, a carbohydrate, a softener or polyol, an enzyme, a pH adjusting agent, a salt, a macronutrient, and a micronutrient.

In some embodiments, also provided herein are high moisture extrudates comprising: about 40-50 wt. % of a dry blend of components; about 30-60 wt. % of water; and about 0-20 wt. % of a ribulose 1,5-bisphosphate (RuBP) carboxylase/oxygenase (RuBisCO) emulsion. In some embodiments, the dry blend of components comprises about 70-90 wt. % of a pea protein isolate, about 5-20 wt. % of pea fiber, and about 0-15 wt. % of a RuBisCO protein isolate. In some embodiments, the RuBisCO emulsion comprises about 5-15 wt. % of a RuBisCO protein isolate, about 35-45 wt. % of the water, about 0-3 wt. % of a flavor, and about 40-50 wt. % of an oil. In some embodiments, the high moisture extrudate allows for a high inclusion of the oil without disrupting a fibrous structure formation during cooling and provides an improved fatty mouthfeel perception upon consumption.

In some embodiments, also provided herein are directionally frozen highly fibrous scaffolds generated from a solution of a ribulose 1,5-bisphosphate (RuBP) carboxylase/oxygenase (RuBisCO) protein isolate, an additive, and water. In some embodiments, the additive is selected from the group consisting of: a protein isolate, a protein concentrate, a starch, a gum, a flavor, and a colorant. In some embodiments, the protein isolate is selected from the group consisting of: a pea protein isolate, a faba bean protein isolate, a wheat protein isolate, a soy protein isolate, a mungbean protein isolate, a sunflower protein isolate, a canola protein isolate, a potato protein isolate, a RuBisCO protein isolate, a rice protein isolate, a hemp protein isolate, a lentil protein isolate, a chickpea protein isolate, a pumpkin protein isolate, a transglutaminase, a tyrosine oxidase, and a lysyl oxidase. In some embodiments, the protein concentrate is selected from the group consisting of: a pea protein concentrate, a faba bean protein concentrate, a wheat protein concentrate, a soy protein concentrate, a mungbean protein concentrate, a sunflower protein concentrate, a canola protein concentrate, a potato protein concentrate, a RuBisCO protein concentrate, a rice protein concentrate, a hemp protein concentrate, a lentil protein concentrate, a chickpea protein concentrate, and a pumpkin protein concentrate. In some embodiments, starch is selected from the group consisting of a corn starch, a potato starch, a mungbean starch, a rice starch, a chickpea starch, a tapioca starch, and a pea starch. In some embodiments, gum is selected from the group consisting of: a xantham gum, a curdlan gum, a gellan gum, a carrageenan, a guar gum, a gum acacia, a tamarind seed gum, an alginate, a carboxymethylcellulose, a methylcellulose, a microcrystalline cellulose, a locust bean gum, and a pectin. In some embodiments, a structure or strength of the directionally frozen highly fibrous scaffold is modulated based on a concentration of the RuBisCO protein isolate, a method, and a temperature of a setting of the directionally frozen highly fibrous scaffold and other additives. In some embodiments, the directionally frozen highly fibrous scaffold is post-processed to serve as a whole-cut meat product. In some embodiments, the directionally frozen highly fibrous scaffold is used as a fibrous and protein-rich scaffold for cell culturing to generate a hybrid cultivated meat product.

### EXAMPLES

### Example 1: High Moisture Extrusion Process of Protein Isolate

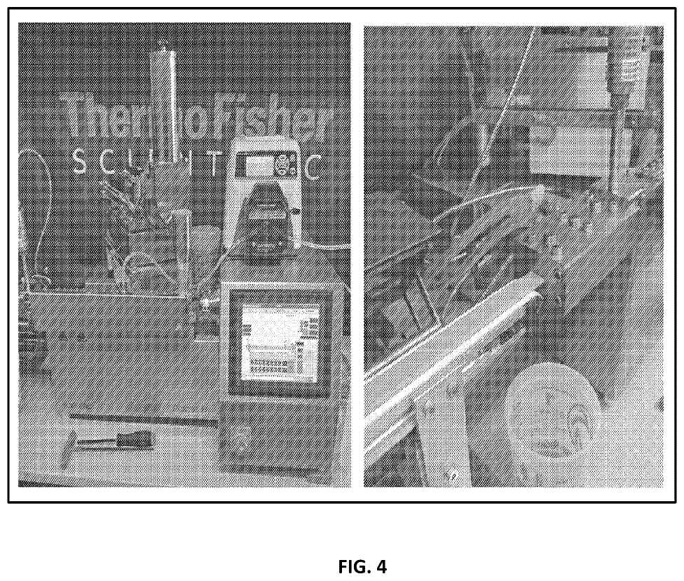

The method of FIG. 2 was used herein. In an example, the soy protein concentrate 106 was a Solae Alpha 11 IP soy protein concentrate (hereinafter as “SPC”) and the pea protein isolate 108 was a Roquette F85S pea protein isolate (hereinafter as “PPI”). The RuBisCO protein isolate 104 was P060121 (hereinafter as “RPI”). Equipment for the high moisture extrusion process 110, as shown in FIG. 4, included use of a Thermo Scientific Process 11 mm twin screw extruder outfitted with a gravimetric powder feeder, peristaltic liquid feeder, and Thermo designed high moisture die connected to a chiller. The L/D of the extruder is 40 and a length of the die is about 7 inches (about 17.78 cm) with an about 0.7×0.15 inch (or 1.778×0.381 cm) rectangular opening.

The screw profile of the extrusion was the standard pharma compounding setup, with a conveying section, two mixing sections, and a compression section prior to entering the die. The temperature profile of the extruder is shown below in TABLE 3.

TABLE 3
EXEMPLARY TEMPERATURE PROFILE

| | Zone | Zone | Zone | Zone | Zone | Zone | Zone | | |
|---|---|---|---|---|---|---|---|---|---|
| | 2 | 3 | 4 | 5 | 6 | 7 | 8 | Die Adapter | Die |
| Temperature | 60 | 60 | 60 | 60 | 80 | 80 | 100 | 120 | 60 |
| (° C.) | | | | | | | | | |

Powder (e.g., the proteinaceous composition 102) was fed gravimetrically at about 0.2 kg/hr. and water was fed at about 0.3 kg/hr., with a total feed of about 0.5 kg/hr. and the extrudate (e.g., the extruded protein product 112) having a moisture content of about 60%. The extrudate (e.g., the extruded protein product 112) was collected on an offtake conveyer belt, cooled to an ambient temperature, and was immediately frozen until analyzed. The extrudate (e.g., the extruded protein product 112) was made using the different configurations of the proteinaceous composition 102 shown in TABLE 4. Sample powders were blended in a mixer prior to feeding.

TABLE 4
EXEMPLARY PROTEIN COMPOSITIONS

| Soy Protein Concentrate | Pea Protein Isolate |
|---|---|
| 100% SPC | 100% PPI |
| 90% SPC/10% RPI | 90% PPI/10% RPI |
| 80% SPC/20% RPI | 80% PPI/20% RPI |
| | 50% PPI/50% RPI |

Texture analysis was performed using a TA EXP XT2i texture analyzer with a 20 kg load cell and a modified Ottawa cell to perform shear testing. Three 1.5 inch (3.81 cm) extrudate samples (e.g., the extruded protein product 112 samples) equilibrated to room temperature were placed in the cell and the probe was applied at about 3 mm/s for a total deflection of about 30 mm. The peak force was recorded as the shear strength and divided by 3 to yield the shear strength of the extrudate. The reported results are the average of at least 4 measurements.

### Example 2: Soy Protein Concentrate

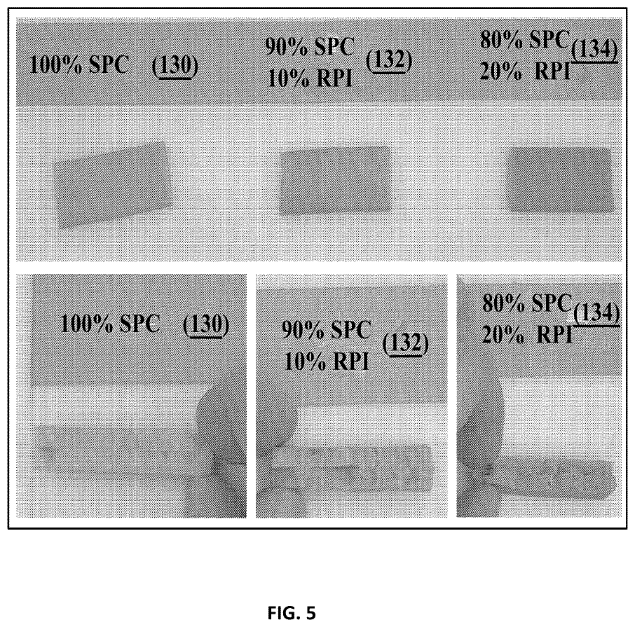

FIG. 5 depicts soy protein concentrate or SPC extrudates (e.g., the extruded protein product 112) produced with varied levels of the RuBisCO protein isolate 104. Specifically, FIG. 5 depicts a first SPC extrudate 130 having 100% SPC, a second SPC extrudate 132 having 90% SPC/10% RPI, and a third SPC extrudate 134 having 80% SPC/20% RPI. The cross-section images shown in FIG. 5 highlights the changes in fibrosity resulting from an increase in the RuBisCO protein isolate 104.

The first SPC extrudate 130 having 100% SPC exhibited a light color and some fibrosity upon breaking the extrudate (e.g., the extruded protein product 112). Additionally, the second SPC extrudate 132 having 90% SPC/10% RPI and the third SPC extrudate 134 having 80% SPC/20% RPI exhibited higher qualitative fibrosity upon breaking and a darkening in color. Further, 50% SPC/50% RPI was unable to be extruded due to the density difference of the materials and uneven gravimetric powder feeding resulting in unstable product. The RPI addition did not cause an unpleasant odor or taste to the final extrudates.

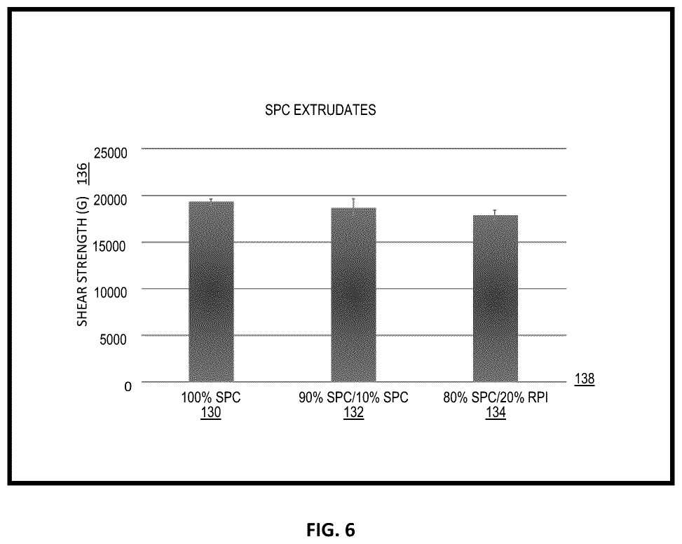

FIG. 6 illustrates a graph depicting shear strength of the SPC extrudates. Specifically, FIG. 6 includes an x-axis 138 associated with varying configurations of the SPC extrudates and a y-axis 136 associated with shear strength (measured in g). The first SPC extrudate 130 having 100% SPC, the second SPC extrudate 132 having 90% SPC/10% RPI, and the third SPC extrudate 134 having 80% SPC/20% RPI are depicted in FIG. 6.

Texture analysis of the extrudates indicated a diminishment in shear strength with increasing RuBisCO content. The addition of about 10% of RPI decreased shear strength by about 3.26% and the addition of about 20% of RPI decreased shear strength by about 7.15%. This decrease is due to starch in the concentrate driving some of the shear strength, with the addition of the RPI effectively diluting the starch in the extrudate. The apparent increase in fibrosity with increasing RPI indicates a synergy between the RPI and the starch in inducing phase separation and the formation of more and smaller fibers.

### Example 3: Pea Protein Isolate

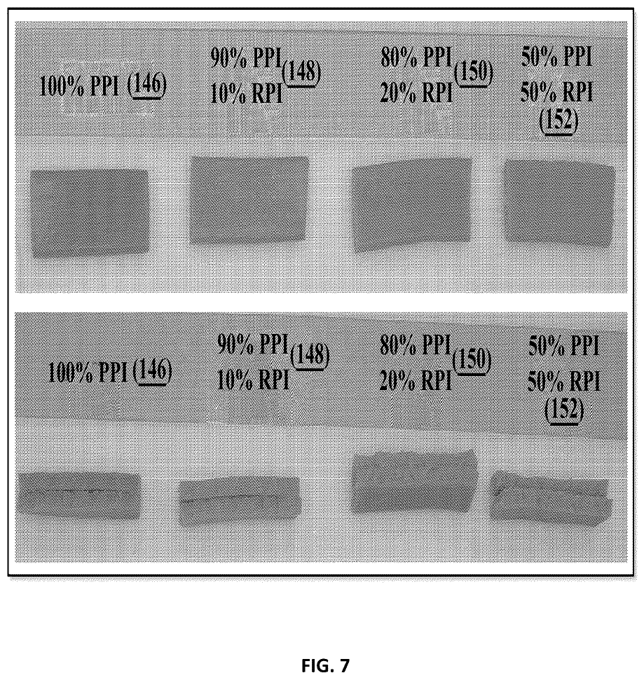

FIG. 7 depicts pea protein isolate (PPI) extrudates (e.g., the extruded protein product 112) produced with varied levels of the RuBisCO protein isolate 104. The images in FIG. 7 show the extruded samples and the cross-section highlighting the changes in fibrosity in response to increased RuBisCO protein isolate. More specifically, FIG. 7 includes a first PPI extrudate 146 having 100% PPI, a second PPI extrudate 148 having 90% PPI and 10% RPI, a third PPI extrudate 150 having 80% PPI and 20% RPI, and a fourth PPI extrudate 152 having 50% PPI and 50% RPI.

The PPI extruded at 100% (e.g., the first PPI extrudate 146) was dark brown, did not exhibit fibrosity, and had a gummy texture with a strong pea protein off-flavor and odor. The addition of RPI to the PPI visually improved the fiber formation slightly, but it was not dramatic. However, the color, odor, and flavor were dramatically reduced with increased RPI content.

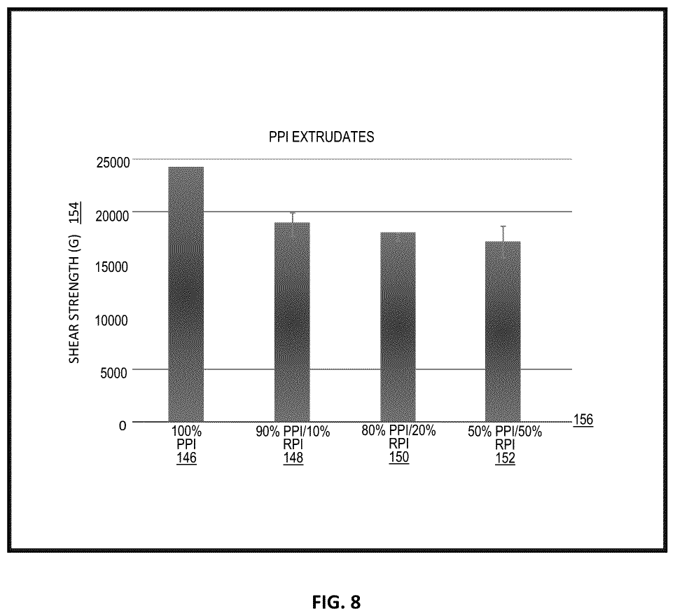

FIG. 8 illustrates a graph depicting the shear strength of the PPI extrudates. FIG. 7 includes an x-axis 156 associated with varying configurations of the PPI extrudates and a y-axis 154 associated with shear strength (measured in g). The first PPI extrudate 146 having 100% PPI, the second PPI extrudate 148 having 90% PPI and 10% RPI, the third PPI extrudate 150 having 80% PPI and 20% RPI, and the fourth PPI extrudate 152 having 50% PPI and 50% RPI are depicted in FIG. 7.

As shown in FIG. 8, texture analysis of the extrudates indicated a diminishment in shear strength with increasing RuBisCO content. The addition of 10% of RPI decreased shear strength by about 22.29%, the addition of about 20% of RPI decreased shear strength by about 25.93%, and the addition of about 50% of RPI decreased shear strength by about 29.68%. The higher loss in shear strength exhibited by the PPI and RPI extrudates indicates that the gel strength of extruded RPI in a PPI matrix is weaker than PPI alone. Based on the SPC results, it is shown that adding in starch with the RPI improves the fibrosity without compromising the shear strength.

Based on the foregoing, use of the RuBisCO isolate 104 can have a potentially positive effect on SPC extrudates and PPI extrudates. The lower organoleptic properties of RPI improves the flavor and color of PPI, a common issue with PPI extrudates. Based on the SPC results, starch-RPI interactions may be beneficial to increasing fibrosity of SPC high moisture extrudates. Adding in starch to the PPI extrudates with RPI may exhibit synergistic effects that could improve fibrosity. This instant invention also contemplates additional ways to produce small and large scale high-moisture extrudate samples with RPI in soy and pea matrices with varied levels of starch to fully understand the impact of RPI on high moisture systems.

### Example 4: 62 mm Extrusion

A high moisture extrudate (e.g., the extruded protein product 112) was produced on a 62 mm Buhler extruder with a rectangular cooling die, consisting of a dry blend, water, and an emulsion. The total throughput was about 14-16 kg/hr. and the composition was about 40-50 wt. % of the dry blend, about 30-60 wt. % of water, and about 0-20 wt. % of the emulsion. The dry blend consisted of about 70-90 wt. % of the PPI, about 5-20 wt. % of pea fiber, and about 0-15 wt. % of the RuBisCO protein isolate 104. The emulsion consisted of about 5-15 wt. % of the RuBisCO protein isolate 104, about 35-45 wt. % of the water, about 0-3 wt. % of the flavor, and about 40-50 wt. % of the canola oil that was emulsified with a high-speed homogenizer at about 5000-15000 rpm for a time period of about 2-15 minutes prior to use.

The dry blend and water was processed with the twin screw extruder and the emulsion was introduced into the barrel immediately prior to the cooling die via a pump. The extrusion dough was set and cooled into a fibrous meat-like product via the cooling die. The samples were cut, immediately vacuum sealed, and then frozen prior to analysis.

The extrudate (e.g., the extruded protein product 112) was evaluated via sensory profiling. Samples produced with the emulsion and flavor included had a higher liking score and a more moist mouthfeel as compared to the samples without the emulsion. Additionally, the emulsion integration allowed for inclusion of up to about 6.5 wt. % of the oil into the extrudate (e.g., the extruded protein product 112), where typical high moisture extrusion systems are limited to levels up to about 2 wt. %. The highest sensory scored extrudate system with the RuBisCO emulsion included consisted of: about 30 wt. % of the PPI, about 10 wt. % of the pea fiber, about 47 wt. % of the water, and about 13 wt. % of the RuBisCO emulsion (e.g., about 43 wt. % of the water, about 50 wt. % of the canola oil, about 6 wt. % of the RuBisCO, and about 1 wt. % of the flavoring component/flavor).

As such, the present invention provides a high moisture protein and protein/fiber extrudate (e.g., the extruded protein product 112) that includes a RuBisCO stabilized emulsion, which allows for higher inclusion of oil into the extrudate (e.g., the extruded protein product 112) without disrupting fibrous structure formation during cooling and for an improved fatty mouthfeel perception upon consumption.

### Example 5: Directional Freezing

### Example 5.1: Whole Meat Material Construction

Fibrous materials are generated from RuBisCO and additives via a directional freezing and then setting approach. A solution of about 2-20 wt. % of the RuBisCO protein isolate 104 and about 0.1-5 wt. % of an additive is made, with the rest of the weight percentage being made up with water. The additive may comprise a protein isolate, protein concentrate, starch, gum, flavor, and/or colorants.

The protein isolate may include: pea protein isolate, faba bean protein isolate, wheat protein isolate, soy protein isolate, mungbean protein isolate, sunflower protein isolate, canola protein isolate, potato protein isolate, RuBisCO protein isolate, rice protein isolate, hemp protein isolate, lentil protein isolate, chickpea protein isolate, pumpkin protein isolate, transglutaminase, tyrosine oxidase, and/or lysyl oxidase, among other protein isolates not explicitly listed herein. The protein concentrate may include: pea protein concentrate, faba bean protein concentrate, wheat protein concentrate, soy protein concentrate, mung bean protein concentrate, sunflower protein concentrate, canola protein concentrate, potato protein concentrate, RuBisCO protein concentrate, rice protein concentrate, hemp protein concentrate, lentil protein concentrate, chickpea protein concentrate, and/or pumpkin protein concentrate, among other concentrates not explicitly listed herein. The starch may include: corn starch, potato starch, mung bean starch, rice starch, chickpea starch, tapioca starch, and/or pea starch, among other starches not explicitly listed herein. The gum may include: xantham gum, curdlan gum, gellan gum, carrageenan, guar gum, gum acacia, tamarind seed gum, alginate, carboxymethylcellulose, methylcellulose, microcrystalline cellulose, locust bean gum, and/or pectin, among other gums not explicitly listed herein.

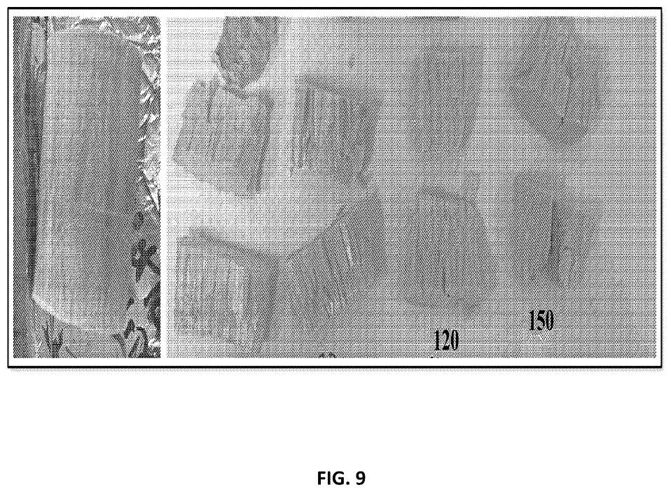

The materials are completely dissolved via stirring or hand blending. The solutions are then placed into Teflon insulated containers with metal on the bottom or on both the bottom and the top. The metal portion of the containers are placed in direct contact with dry ice, a dry ice bath (consisting of dry ice with water, ethanol, methanol, hexane, ethyl acetate, or any combination thereof), or liquid nitrogen and allowed to freeze. The freezing and heat transfer only takes place where the metal component of the container is in contact with the freezing medium. This can allow for the proteins to align perpendicularly to the freezing surface and to propagate into fibrous structures as they are directionally frozen. FIG. 9 depicts images of dried directionally frozen RuBisCO fibrous scaffolds, according to at least some embodiments disclosed herein.

The structures are then set via drying and heat setting or solvent extraction. The first method includes freeze drying the frozen structures at a pressure of about 200-500 mTorr and a temperature of about 25-40° C. for a time period of about 12-48 hours. Next, the dried materials are then heat set by heating in a convective oven at a temperature of about 90-180° C. for a time period of about 1-4 hours. The second method includes the frozen structures being set by a solvent exchange method with an about 50-100 vol. % of ethanol and an about 0-50 vol. % of a water solution. Next, the structure is solidified in the insoluble solvent and then further dried in a convective oven at a temperature in a range of about 40-60° C. for a time period in a range of about 1-4 hours.

This process results in a dried scaffold that has highly aligned protein rich fibers that form a cohesive and self-standing fibrous product that can be further processed to generate a meat-like whole cut product. The dried and set fibrous construct is then rehydrated in a solution that can consist of: water, oil, protein isolate, protein concentrate, starch, gum, fiber, flavor, and/or colorant or any mixture therein. Examples of the oil include: canola oil, safflower oil, coconut oil, cocoa butter, sunflower oil, grapeseed oil, olive oil, peanut oil, avocado oil, corn oil, and/or palm oil, among other oils not explicitly listed herein. Examples of the fiber include: psyllium fiber, citrus fiber, pea fiber, corn fiber, and/or mung bean fiber, among other fibers not explicitly listed here.

As an illustrative example, relevant levels of the rehydration solution components include the following: about 40-100 wt. % of the water, about 0-60 wt. % of the oil, about 0-20 wt. % of the protein isolate, about 0-20 wt. % of the protein concentrate, about 0-10 wt. % of the starch, about 0-5 wt. % of the gum, about 0-10 wt. % of the fiber, about 0-20 wt. % of the flavor, and about 0-5 wt. % of the colorant.

Moreover, the construct is immersed in the rehydration solution at a temperature in a range of about 20-40° C. and a pressure in a range of about 200-760000 mTorr for a time period in a range of about 0.1-4 hours. The construct is then removed from the rehydration solution and may be further subjected to a heating cycle at a temperature in a range of about 30-80° C. for a time period in a range of about 1-4 hours or a freeze thaw cycle. The resulting rehydrated fibrous scaffold can then be further cooked and eaten as a whole-cut meat like product.

### Example 5.2: Scaffolds for Cellular Agriculture

Fibrous dried scaffolds are prepared as previously described in Section A entitled “Whole Meat Material Construction,” but are then sterilized via ethanol, UV light, and/or gamma irradiation. The scaffolds are then rehydrated in ultrapure water at a temperature of about 37° C. Next, the scaffolds are introduced to mammalian and fish cells, including satellite cells, epithelial cells, endothelial cells, fibroblasts, and/or smooth muscle cells, derived from bovine, porcine, chicken, fish, or other animal sources. The cells are grown on the scaffold in a growth medium that contains growth medium that consists of Dulbecco's modified Eagle's medium, fetal bovine serum, neonatal calf serum, and other growth factors.

The scaffolds are cultured with the cells at a temperature of about 37° C., about 5% CO₂, and for a time period of about 4-7 days prior to evaluation. After growth, the cultured scaffolds are evaluated via confocal microscopy for cell differentiation and morphology, ELISA, proteomic analysis, and Western Blotting for biomarker quantification. Successful scaffolds are able to promote adherence and differentiation of animal cell lines to form myotubes and adipose structures for applications as hybrid plant-based and cultivated meat products.

As such, a directionally frozen highly fibrous scaffold is able to be generated using RuBisCO as the main protein fiber forming agent. The strength and structure of the construct is modulated by the concentration of RuBisCO, method and temperature of construct setting, and other additives using during the directional freezing process. The set construct can then be further post-processed to serve as a whole-cut meat product or utilized as a fibrous protein-rich scaffold for cell culturing to generate a hybrid cultivated meat product.

### Example 6: Fiber Spinning and Electrospinning

### Example 6.1: Wet Spinning

Individual fibers and fiber bundles consisting primarily of RuBisCO and additives are generated via a wet spinning process. A solution of about 2-30 wt. % RuBisCO and about 0.1-10 wt. % of the additive is made with the rest of the weight percent being made up with water at a pH in a range of 2-12. The additive can consist of the protein isolate, the protein concentrate, the starch, the gum, the flavor/flavoring component, and/or the colorant described herein. Additionally, the additive can consist of a polymer component consisting of polyethylene oxide, polyvinyl alcohol, and/or chitosan. The materials are completely dissolved via stirring or hand blending. The solution is then pumped through a spinneret consisting of about 1-20,000 cylindrical orifices in the size range of about 0.01-2 mm.

It should be appreciated that the solution immediately goes through a setting process that can consist of the application of dry air, heating at a temperature in a range of 60-150° C., immersion in a setting bath, or any combination of these methods. The setting bath can consist of water, ethanol, or any level of mixture of the two. In some instances, the bath is at a pH in a range of 2-12 and the pH adjustment can be achieved by using hydrochloric acid, sulfuric acid, acetic acid, phosphoric acid, sodium hydroxide, potassium hydroxide, calcium hydroxide, or ammonium sulfate. In some instances, the bath further comprises a cross-linking agent consisting of a single component or mixture of calcium chloride, magnesium chloride, zinc chloride, iron chloride, manganese chloride, copper chloride, and/or cobalt chloride.

In some instances, after application of the appropriate setting, any residual polyethylene oxide and/or polyvinyl alcohol is washed out with excess water. Fiber spinning with polyethylene oxide or polyvinyl alcohol result in porous fiber construction. The spun fibers are then collected via a spinning drum or cone to pull and stretch the fibers. This will result in fibers having a diameter in a range between about 0.01-2 mm. The collected fibers will be present as rolled fiber bundles that can be further compressed to form fibrous free-standing materials. The fibrous material can then be immersed in the rehydration solution described herein at a temperature in a range of 20-40° C. and at a pressure in a range of about 200-760000 mTorr for a time period in a range of about 0.1-4 hours.

The material can then be removed from the rehydration solution and may be further subjected to a heating cycle at a temperature in a range of 30-80° C. for a time period in a range of 1-4 hours or a freeze thaw cycle. The resulting rehydrated fibrous material can then be further cooked and eaten as a whole-cut meat like product. The fibrous material can also be utilized as a scaffold for cultivated meat applications, as described herein.

### Example 6.2: Electrospinning

Individual fibers and fiber bundles consisting primarily of RuBisCO and additives are generated via an electrospinning process. A solution of about 2-30 wt. % of the RuBisCO and about 0.1-10 wt. % of the additive is made with the rest of the weight percent being made up with water at a pH in a range of 2-12, ethanol, or any ratio of the two. The additive can consist of the protein isolate, the protein concentrate, the starch, the gum, the flavor/flavoring component, and/or the colorant, as described herein.

Additionally, the additive can consist of a polymer component consisting polyethylene oxide, polyvinyl alcohol, and/or chitosan. The materials are completely dissolved via stirring or hand blending. The solution is then pumped through a spinneret consisting of about 1-20,000 cylindrical orifices in the size range of about 0.01-2 mm that is charged to a direct current voltage between about 5-50 kV. The charged solution is ejected from the spinneret and travels to a grounded collection apparatus. The collection apparatus can consist of a flat plate, a slotted plate, a rotating cylinder, and/or a rotating cone. The fibers are set during the spinning process via dry air and heat in a temperature range of 50-180° C. The resulting fibers will have a diameter of about 5-250 nm. The fibers can then be post-processed to create free-standing whole-cut meat products or hybrid cultivated meat products, as previously described.

### Example 7: Three-Dimensional (3D) Printing

As described herein, 3D printed whole meat and fibrous constructs are developed by first creating a bioink consisting primarily of RuBisCO and one or more additives. The additives can consist of the protein isolate, the protein concentrate, the starch, the gum, the flavor/flavoring component, and/or the colorant, as described herein. A solution of about 2-30 wt. % of the RuBisCO and about 0.1-10 wt. % of the additives is made with the rest of the weight percent being made up with water at a pH in a range of 2-12.

Additionally, the bioink can consist of a crosslinker at about 0.1-2 wt. % consisting of riboflavin, transglutaminase, tyrosine oxidase, or lysyl oxidase. The bioink can be pre-heated at a temperature in a range of about 40-90° C. for a time period in a range of about 0.1-4 hours and allowed to cool. The bioink is 3D printed using a standard bioprinting set-up where the bioink solution is extruded through a nozzle with size of about 0.5 0 5 mm. The pressure used during extrusion is between about 1-100 PSI and the extrusion temperature is in a range of about 25-160° C. The stage that the material is printed on can be at a temperature in a range of about 4-60° C. and the printing can be done onto an open platform or into a cross-linking bath.

The cross-linking bath can consist of water, ethanol, or any level of mixture of the two. Additionally, the bath can be at a pH in a range of 2-12 and the pH adjustment can be achieved by using hydrochloric acid, sulfuric acid, acetic acid, phosphoric acid, sodium hydroxide, potassium hydroxide, calcium hydroxide, or ammonium sulfate. The setting bath can also comprise a cross-linking agent consisting of a single component or mixture of calcium chloride, magnesium chloride, zinc chloride, iron chloride, manganese chloride, copper chloride, and/or cobalt chloride.

The 3D printed construct can be fibrous, gelatinous, tubular, or any reasonable geometry consistent with 3D printing limitations. The 3D printed construct can be post-processed via the rehydration procedures described herein and further cooked and consumed as a whole-cut meat product. Additionally, the 3D printed construct can be utilized as a cultivated meat scaffold as described herein.

### Example 8: Whole Meat Material Construction with Optionally Higher Percent RuBiCo Formulations

Fibrous meat compositions were prepared using high purity RuBisCO protein isolate. Initial preparation of the meat compositions used solutions of RuBisCO protein isolate in water. Various amounts of RuBisCO protein isolate were used to elucidate the role of percent weight RuBisCO protein isolate on the meat composition end products. Solutions of 5 weight percent to 40 weight percent of the RuBisCO protein isolate were prepared as aqueous solutions. Additives in amounts from 0.1-5 wt. % of an additive were added to the solutions, with the rest of the weight percentage comprising water. The materials were completely dissolved via stirring or hand blending. For unidirectional freezing, a temperature gradient is established in one direction. A cold temperature is either applied in one direction, or in two parallel directions. The temperature source is chosen from liquid nitrogen, dry ice, or a frozen ice bath. To facilitate heat transfer to the solution from the bath a copper, steel or other conductive metal material can be used to hold the solution. The sides of the encasing in the direction perpendicular to the cold source can be made of insulating material or conducting material. If the sides are conducting, a portion of the product around the edge will need to be discarded as the temperature gradient will not be fully unidirectional.

The directionally frozen samples were then dehydrated using freeze drying under reduced pressure, or using a solvent bath replacement method using an organic solvent. Importantly, this dehydrating step must be used on the directionally frozen samples that are still frozen, and have not melted. The solvent bath replacement method includes introducing the directionally frozen RuBisCO composition into a bath of a solution, or mixture of solutions at a subfreezing temperature. Generally, −8 degrees Celsius or less were adequate temperatures. The bath includes water, an organic solvent or a mixture of these. Exemplary samples tested were introduced to a bath with 0-20% salts including sodium chloride, calcium chloride, ammonium sulfate, or a similar salt using 60% ethanol or 100% acetone. Exemplary ranges of compositions tested are shown below in Table 5.

TABLE 5
Solvent Replacement Bath Dehydration Conditions

| Variable | Range |
|---|---|
| pH | 2-10 |
| Organic solvents | Ethylene glycol, ethanol, isopropyl |
| | alcohol, acetone |
| Water content | 5-100% (remainder is organic |
| | solvent) |
| NaCl | 0-15 wt. % |
| Sodium alginate + | 5-20 wt. % CaCl2 in freezing bath, 0- |
| calcium chloride | 2 wt. % sodium alginate in meat |
| Ammonium sulfate | 0-15 wt. % |

Different bath formulations resulted in dehydrated directionally frozen RuBisCO compositions with increased or decreased bundle preservation in the fibrous structure of the samples. The pH of the bath can be adjusted from 1-10 pH. Additional exemplary components of the bath can include: a gelation agent acetone, ethanol, isopropyl alcohol, sodium hydroxide, sodium bicarbonate, sodium carbonate, sodium chloride, citric acid, acetic acid, sodium citrate, lactic acid, or ascorbic acid. The directionally frozen RuBisCO product is incubated in the bath from a time of 1 hour to 1 week with the bath maintained at the subfreezing temperature selected. at freezing temperatures facilitated drying of the directionally frozen samples.

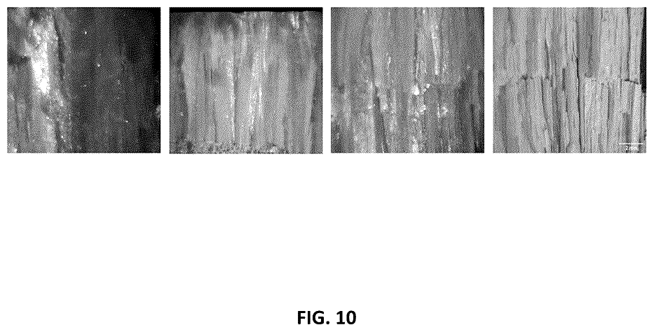

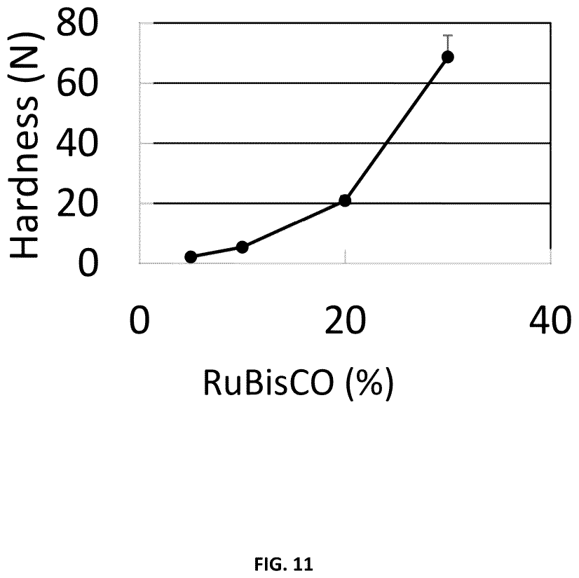

The dehydrated samples then underwent heating to set the compositions which further removed some or all of the residual solvents and/or water present. Heating in a dry oven was used on the dehydrated directionally frozen samples at a temperature between 100 to 150 degrees Celsius for 0.5 to 5 hours. Humidity in the oven can also be adjusted to affect hardness of the resulting food product precursor. FIG. 10 depicts images of dried directionally frozen, freeze dried, and subsequently heat-dried RuBisCO fibrous scaffolds (food product precursor). The hardness of the hydrated final meat product was correlated to the RuBisCO isolate concentration in the starting solution. FIG. 11 shows increasing measurements of hardness versus RuBisCO isolate concentration used in the starting solution. This protocol resulted in a dried scaffold that has highly aligned protein rich fibers that form a cohesive and self-standing fibrous product that can be further processed to generate a meat-like whole cut product.

The dried and set fibrous construct is then rehydrated at a temperature between 1 to 80 degrees Celsius for 30 seconds to 24 hours depending on the temperature of the rehydration solution. In some exemplary compositions the rehydrating solution can contain water, oil, protein isolate, protein concentrate, starch, gum, fiber, flavor, and/or colorant or any mixture therein. Examples of the oil include: canola oil, safflower oil, coconut oil, cocoa butter, sunflower oil, grapeseed oil, olive oil, peanut oil, avocado oil, corn oil, and/or palm oil, among other oils not explicitly listed herein. Examples of the fiber include: psyllium fiber, citrus fiber, pea fiber, corn fiber, and/or mung bean fiber, among other fibers not explicitly listed here.

The food product precursor samples were then hydrated to form the RuBisCO meat food products. The samples were placed in an aqueous hydration bath refrigerated at 4 to 8 degrees Celsius and incubated for 24 to 48 hours for full hydration at the refrigerated temperature. For samples incubated in a bath at 70 degrees Celsius, full hydration was observed qualitatively within 10 minutes. Food product precursor sample thickness determines actual time required for sample hydration. Rehydration methods can use temperatures ranging from 1-100 degrees Celsius depending on the targeted morphological characteristics for the specific RuBisCO meat food product.

### Example 9: Chemical Gelation

Chemical gelation of the directionally frozen compositions can occur using alginate in the RuBisCO isolate starter solution. Gelation can occur by immersing the starter solution in a bath with calcium ions present, cross-linking the material of the composition.

### Example 10: Analytical Methods for Evaluating RuBisCO Meat Compositions

### Example 10.1—Bundle Analyses of Heat-dried RuBisCO Meat Compositions

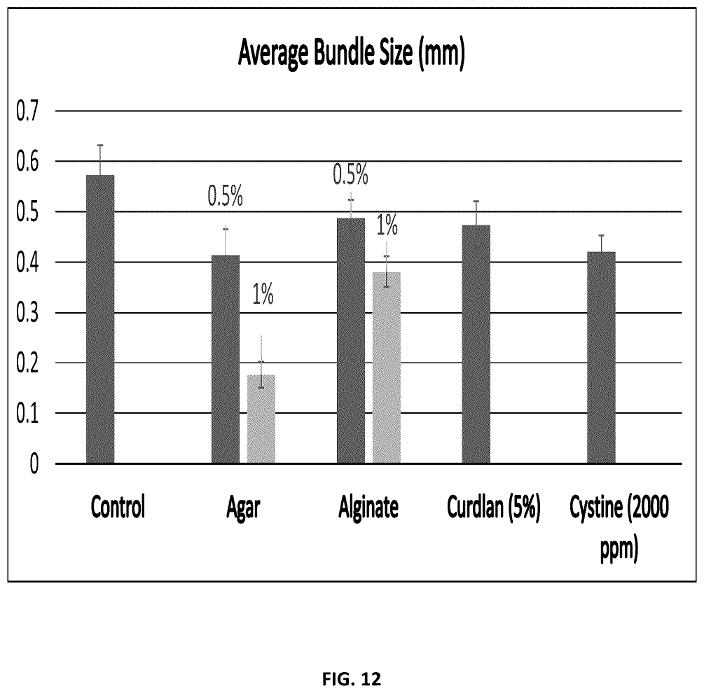

Dry RuBisCO meat compositions that were previously directionally frozen were analyzed for their bundle diameter using a stereoscope. The stereoscope used in the following analyses was an AmScope 3.5×-180× Electronics Inspection Zoom Stereo Microscope with gooseneck LED lights. A stereoscope camera was used to photograph the bundles. The camera used was an OMAX 9 MP USB digital camera for microscope Magnification ranges used for analyses were 0.7 to 2 times magnification. Food product precursors comprising different additives were measured for their average bundle sizes. In the preparation of these food product precursors, the RuBisCO protein isolate starting solutions comprised 20 weight percent for all tested samples. The additives were dispersed into the starting solutions prior to the addition of the RuBisCO protein isolate. The solutions were directionally frozen, using dry ice as the cold source, dehydrated using a freeze drier, and then heated at 120 degrees Celsius for 2 hours in a dry environment resulting in the food product precursor. Alternatively, instead of a freeze dryer, the directionally frozen solution can be dehydrated using a solvent replacement bath described herein. Bundle sizes of the food product precursors were then analyzed and measured. Comparing bundle size of the directionally frozen RuBisCO compositions with the subsequent food product precursors showed a reduction in bundle size of up to 69% depending on the additive used. One exemplary additive used was agar. Exemplary food product precursors prepared with 5, 10, 20, and 30 percent weight RuBisCO solutions were analyzed with a stereoscope with imaging shown in FIG. 10, and results shown in FIG. 11. FIG. 12 shows bundle sizes of food product precursors with different additives used in the RuBisCO isolate starter solutions. Hardness of the hydrated final meat food product is correlated with the RuBisCO starting solution RuBisCO concentration. RuBisCO compositions have diverse morphologies which can be attributed to the low viscosity observed in RuBisCO solutions, in conjunction with the high solubility of RuBisCO in water, and other aqueous solutions.

### Example 10.2—Water Content of Rehydrated RuBisCO Meat Compositions

Meat composition moisture can vary based on hydration time of the heat set meat compositions. Hydration times using a refrigerated aqueous rehydration bath was varied from 1 to 72 hours. Water weight percent then measured for each rehydrated sample. Results showed the water weight percent varied from 67.5 percent to 86 percent. Subsequent partial drying can be used to lower the water content of a rehydrated sample in order to change the texture and hardness of the meat composition.

### Example 10.3—Texture Analysis of Rehydrated RuBisCO Meat Compositions

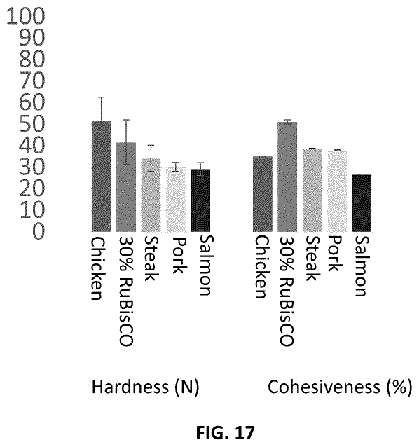

Texture analysis of RuBisCO meat compositions prepared with a directional freezing method described herein were conducted with a MultiTest-I Single-column texture analyzer. Texture measurements were used to mimic twice molar chewing of a bite of food. Each rehydrated RuBisCO meat composition sample was cut into a uniform geometry which was maintained for all samples analyzed for consistency in quantitative analyses. The uniform sample geometry was 38 mm in diameter, and 15 mm in height for each sample. Each sample was placed on the stage of the texture analyzer and a flat, circular TPA probe larger than the sample dimensions, was compressed onto the rehydrated RuBisCO protein isolate meat composition samples in in a direction parallel to each sample. Each sample was compressed two times, sequentially, without pause between compressions. Compression was measured using the initial height of the sample prior to the first compression. Rate of movement and compression percentage were held constant. Compression percentage used was 40 percent for all samples tested. Force required for compression was then measured as a function of time to provide quantitative approximation of sensory attributes in a meat food composition, including harness and cohesiveness. RuBisCO starting solutions with different additives were prepared as described in the bundle analysis above. Hardness analyses showed that hydrated food products prepared with 20 weight percent RuBisCO starting solutions were analyzed for texture using a hardness parameter, measured in Newtons (N), representing highest force measured during the first compression (N) during texture profile analysis. Results of the food products prepared with different additives as described about are shown in FIG. 13. A RuBisCO meat food product prepared with 30% RuBisCO isolate in the starter solution with no additives, and directionally freezing with dry ice, followed by heating in a dry environment at 120 degrees Celsius for two hours was compared with other raw meat food products with results shown in FIG. 17.

Meat food products prepared with 10% RuBisCO isolate, soy, pea, or faba proteins were prepared as directionally frozen compositions using dry ice, freeze drying, followed by heating in a dry environment at 120 degrees Celsius for two hours, and then hydrated. Hardness analyses comparing each showed that the RuBisCO meat food product was harder than the other protein meat products with results shown in FIG. 18. Images of the meat product precursors for each of the plant-based proteins used are shown in FIG. 19.

Hardness and cohesion analyses were also conducted for RuBisCO meat food products prepared with 20 weight percent RuBisCO isolate with 1% or 10% canola oil as a fat additive. Results shown in FIG. 14 show that hardness increased with a higher amount of canola oil. Cohesiveness was measured as the area under the second compression cycle (using the TPA probe) divided by the area under the first compressive cycle during texture profile analysis. The sample prepared with 10% canola oil RuBisCO food product precursor had less cohesiveness in comparison to the 1% canola oil RuBisCO food product precursor, and control RuBisCO food product precursor once rehydrated.

### Example 10.4—Formation Analyses—Effects of Temperature

### Freezing:

Temperature of the cold source used for directional freezing of the RuBisCO isolate starter solution was analyzed with regard to resulting bundle diameter with results shown in FIG. 15A. It was shown that bundle diameter increases with an increased formation temperature during directional freezing, while the related RuBisCO meat food product hardness measure decreases with an increased formation temperature during directional freezing with results shown in FIG. 15B. Of note, the hardness of the RuBisCO composition is consistently measured when the RuBisCO composition is the food product precursor (previously heated). Timing to freeze the RuBisCO composition was shown to require approximately 1 minute or less when liquid nitrogen is used. In alternative temperature baths at higher temperatures, freezing of the RuBisCO composition took up to 1 hour or more. The salt water bath had a temperature of about −10 degrees Celsius, the ethylene glycol with dry ice bath has a temperature of about −40 degrees Celsius, the dry ice bath had a temperature of about −78 degrees Celsius, the ethanol and liquid nitrogen combination bath had a temperature of about −116 degrees Celsius, and the liquid nitrogen bath had a temperature of about −196 degrees Celsius.

### Heating:

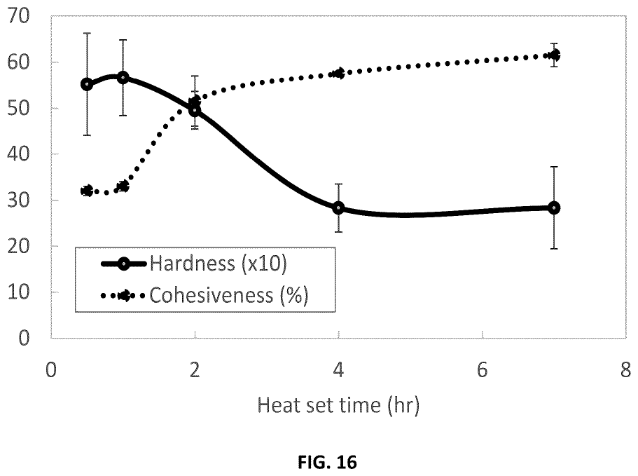

Generation of the food product precursor required directional freezing followed by dehydration (see FIG. 3). To form the food product precursor, the dehydrated, directionally frozen composition underwent heating to set the composition so it remains unchanged in consistency and structure at room temperature. Temperatures used for the RuBisCO compositions were between 100 degrees Celsius and 150 degrees Celsius. Some samples were heated using a humidified heating apparatus. Some samples were heated using a dry environment heating apparatus. Increased hardness of the food product precursors was achieved using a humid environment for heating of up to 75% hardness when the composition contained 20% weight RuBisCO isolate, without additives, directionally frozen with dry ice, dehydrated by freeze drying and then heating at 120 degrees Celsius. Heating duration of the samples ranged from under 30 minutes to 7 hours. Results are shown in FIG. 16 which show that hardness of the resulting food decreases when the RuBisCO composition to form the food product precursor was heated with longer heating times.

### Example 11: Storage Analyses of Heat-dried RuBisCO Meat Compositions

The compositions of the preceding examples are subjected to analysis of composition stability over time. The heat set (un-rehydrated) compositions can be stored over time. Texture analyses on rehydrated samples using heat set compositions stored for different time periods can be conducted. Visual, qualitative analyses comparing bundle appearance can be evaluated.

### Example 12: RuBisCo Production

Workflow A. One kg of fresh Lemna minor was macerated in a Vitamix Blender (Vitamix Corp, Cleveland, Ohio) in a ratio of 1:1 with a sodium carbonate buffer containing 0.3% w/v sodium bisulfite. The extraction was performed for 3 minutes at medium speed setting maintaining the temperature at less than 30° C. Subsequently, the macerated biomass was filtered by using a nylon straining bag (Natural Home Brands, Sun Valley, California) with a fine mesh to separate the fibrous high solids cake from the liquid juice containing the soluble protein. The filtered homogenate was then centrifuged for 10 minutes at a speed/force of 4000 g (Allegra X15R, SX4750 rotor; Beckman Coulter, Inc., Pasadena, California). The pellet was discarded, and the supernatant was collected separately. The solution was heated to a temperature of 50° C. in a water bath that was set at a temperature of 55° C. and was cooled rapidly to a temperature less than 15° C. after reaching the target temperature. Following the rapid cooling of the protein solution, 2% v/v of activated chitosan and 4% w/v of activated carbon (Cabot Norit Americas Inc, Marshall, Texas) is added to the liquid juice. The solution was subsequently stirred for 5 minutes after which the solution was centrifuged for 10 minutes at a speed/force of 5000 g (Allegra X15R, SX4750 rotor; Beckman Coulter, Inc., Pasadena, California). The green pellet in the centrifuge bottle was discarded, and the clear yellow supernatant was micro filtered using a 0.7 pm Glass Micro fiber membrane (Whatman 1825-047 Glass Microfiber Binder Free Filter, 0.7 Micron; Global Life Sciences Solutions USA LLC, Marlborough, Massachusetts). The filtrate was subsequently exposed to a 0.2 pm polyethersulfone membrane (Polyethersulfone (PES) Membrane Filters, 0.2 Micron; Sterlitech Corporation Inc, Kent, Washington) to remove the remainder of the undesired particles including bacteria. The obtained pale yellow and deodorized proteinaceous solution was then concentrated using a 70 kDa membrane (MINIKROS® S02-E070-05-N; Spectrum Laboratories, Inc., Rancho Dominguez, California). The concentrated solution obtained was subsequently freeze dried (Harvest Right LLC, Salt Lake City, Utah) and the result was a white, odorless and soluble protein powder.

Workflow B. One kg of fresh Lemna minor was macerated using a Vitamix Blender (Vitamix Corp, Cleveland, Ohio) in a ratio of 1:1 with a potassium phosphate buffer containing 0.3% w/v ascorbic acid. The maceration was performed for a period of 3 minutes at medium speed in order to maintain a temperature of less than 30° C. The lysed biomass was filtered by using a nylon straining bag (Natural Home Brands, Sun Valley, California) with a fine mesh to separate the fibrous high solids cake from the liquid juice containing the soluble protein. The filtered homogenate was then centrifuged for 10 minutes at a speed/force of 4000 g (Allegra X15R, SX4750 rotor; Beckman Coulter, Inc., Pasadena, California). The pellet was discarded, and the supernatant was collected separately. The supernatant was then mixed with 5% v/v of activated chitosan (Chitosan (10-120 cps), fungal origin (9012-76-4); Glentham Life Sciences Ltd., Corsham, Wiltshire, UK) and 10% w/v of activated carbon (Cabot Norit Americas Inc, Marshall, Texas) for a period of 5 minutes. Subsequently the mixed solution was centrifuged at a speed/force of 5000 g for 10 minutes (Allegra X15R, SX4750 rotor; Beckman Coulter, Inc., Pasadena, California). The obtained pellet was discarded, and the deodorized and decolored supernatant was microfiltered using a 0.2 pm polyethersulfone membrane (Polyethersulfone (PES) Membrane Lilters, 0.2 Micron; Sterlitech Corporation Inc, Kent, Washington). The obtained pale yellow and deodorized proteinaceous solution was then concentrated using a 70 kDa membrane (MINIKROS® S02-E070-05-N; Spectrum Laboratories, Inc., Rancho Dominguez, California). The concentrated solution obtained was subsequently freeze dried (Harvest Right LLC, Salt Lake City, Utah) and the result was a white, odorless and soluble protein powder.

Workflow C. One kg of fresh Lemna minor was macerated using a Vitamix Blender (Vitamix Corp, Cleveland, Ohio) in a ratio of 1:1 with distilled water containing 0.3% w/v of sodium bisulfite and ascorbic acid. The maceration was performed for a period of 3 minutes at medium speed in order to maintain a temperature of less than 30° C. The lysed biomass was filtered by using a nylon straining bag (Natural Home Brands, Sun Valley, California) with a fine mesh to separate the fibrous high solids cake from the liquid juice containing the soluble protein. The filtered homogenate was then centrifuged for 10 minutes at a speed/force of 4000 g. The pellet was discarded, and the supernatant was collected separately. The supernatant was then mixed with a solution containing 30 mM of potassium phosphate and 20 mM of calcium chloride for a period of 5 minutes. Subsequently the mixed solution was centrifuged at a speed/force of 5000 g for 10 minutes (Allegra X15R, SX4750 rotor; Beckman Coulter, Inc., Pasadena, California). The obtained pellet was discarded. 5% w/v of activated carbon (Cabot Norit Americas Inc, Marshall, Texas) was added to the supernatant, and the solution was stirred for 5 minutes. Subsequently, the mixed solution containing the activated carbon was micro filtered using a 0.2 pm polyethersulfone membrane filter (Polyethersulfone (PES) Membrane Filters, 0.2 Micron; Sterlitech Corporation Inc, Kent, Washington) in order to remove the activated carbon that had adsorbed the remaining chlorophyll, polyphenol and other unwanted taste/color/odor impacting particles. The obtained pale yellow and deodorized proteinaceous solution was then concentrated using a 100 kDa membrane (Hollow Fiber Cartridge, 100,000 NMWC, 850 cm2; GE Healthcare Bio-Sciences Corp, Westborough, Massachusetts). The concentrated solution obtained was subsequently freeze dried and the result was a white, odorless and soluble protein powder.

Workflow D. One kg of fresh Lemna minor was macerated using a Vitamix Blender (Vitamix Corp, Cleveland, Ohio) in a ratio of 1:1 with distilled water containing 0.5% w/v of sodium bisulfite. The maceration was performed for a period of 3 minutes at medium speed in order to maintain a temperature of less than 30° C. The lysed biomass was filtered by using a nylon straining bag (Natural Home Brands, Sun Valley, California) with a fine mesh to separate the fibrous high solids cake from the liquid juice containing the soluble protein. The filtered homogenate was then centrifuged for 10 minutes at a speed/force of 4000 g (Allegra X15R, SX4750 rotor; Beckman Coulter, Inc., Pasadena, California). The pellet was discarded, and the supernatant was collected separately. The supernatant was then mixed with a solution containing 30 mM of potassium phosphate and 20 mM of calcium chloride for a period of 5 minutes. Subsequently the mixed solution was centrifuged at a speed/force of 5000 g for 10 minutes (Allegra X15R, SX4750 rotor; Beckman Coulter, Inc., Pasadena, California). The obtained pellet was discarded. 2% w/v of activated chitosan (Chitosan (10-120 cps), fungal origin (9012-76-4); Glentham Life Sciences Ltd., Corsham, Wiltshire, UK) and 4% of activated carbon (Cabot Norit Americas Inc, Marshall, Texas) were added to the supernatant, and the solution was stirred for 5 minutes. Subsequently the mixed solution was centrifuged at a speed/force of 5000 g for 10 minutes (Allegra X15R, SX4750 rotor; Beckman Coulter, Inc., Pasadena, California). The obtained pellet was discarded, and the deodorized and decolored supernatant was microfiltered using a 0.7 pm polyethersulfone membrane (Whatman 1825-047 Glass Microfiber Binder Free Filter, 0.7 Micron; Global Life Sciences Solutions USA LLC, Marlborough, Massachusetts). The filtrate was then further microfiltered using a 0.2 pm polyethersulfone membrane (Polyethersulfone (PES) Membrane Filters, 0.2 Micron; Sterlitech Corporation Inc, Kent, Washington). The obtained pale yellow and deodorized proteinaceous solution was then concentrated using a 70 kDa membrane (MINIKROS® S02-E070-05-N; Spectrum Laboratories, Inc., Rancho Dominguez, California). The concentrated solution obtained was subsequently freeze dried (Harvest Right LLC, Salt Lake City, Utah) and the result was a white, odorless, and soluble protein powder.

Purity analysis from Workflows A-D. The average purity of the protein preparations prepared by the methods of Workflows A-D was about 84.3% and the concentration of soluble protein after ultrafiltration was 1,316 pg/mL. The foaming capacity achieved was 195% and maintained a 92% stability after 1 hour. Gelation properties of the freeze-dried material were validated, and only 2% w/v of freeze-dried material was needed to be added in order to form a gel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A method of heating a composition, the method comprising:
heating a composition comprising a frozen ribulose-1,5-bisphosphate carboxylase/oxygenase (RuBisCO) protein isolate to generate a heated RuBisCO composition comprising a substantially unidirectional morphology and a substantially uniform structure in a solid form, wherein the substantially unidirectional morphology comprises a macroscopic fibrous structure comprising interconnected vertical bundles of the heated RuBisCO composition.

2. The method of claim 1, wherein the heating partially dehydrates the heated RuBisCO composition.

3. The method of claim 1, wherein the heating dehydrates the heated RuBisCO composition.

4. The method of claim 1, wherein the heating of the composition generates a heated RuBisCO composition that is a food product precursor.

5. The method of claim 1, wherein the heating results in the macroscopic fibrous structure remaining unchanged at room temperature.

6. The method of any one of claims 1 to 4, wherein the substantially unidirectional morphology comprises interconnected vertical bundles having an average diameter of 0.1 to 0.8 millimeters.

7. The method of claim 1, further comprising rehydrating the heated RuBisCO composition.

8. The method of claim 7, wherein the rehydrating thereby generates a food product.

9. The method of claim 1, wherein the composition further comprises animal meat or an animal meat component.

10. The method of claim 1, wherein the composition further comprises a fiber, a starch, and/or a lecithin.

11. The method of claim 1, wherein the animal meat component comprises heme or hemoglobin.

12. The method of claim 1, wherein the composition further comprises an additive, a flavoring agent, or a coloring agent.

13. The method of claim 1, wherein the RuBisCO protein isolate is free of chlorophyll.

14. The method of claim 1, wherein the RuBisCO protein isolate is flavorless and colorless.

15. The method of claim 1, wherein the RuBisCO protein isolate comprises a large subunit and a small subunit of RuBisCO protein.

16. The method of claim 1, wherein the RuBisCO protein isolate comprises protein comprising a sequence at least 90% identical to any one of SEQ ID NO: 1 to SEQ ID NO: 10.

17. The method of claim 1, wherein the RuBisCO protein isolate comprises protein comprising a sequence at least 95% identical to any one of SEQ ID NO: 1 to SEQ ID NO: 10.

18. The method of claim 1, wherein the RuBisCO protein isolate comprises protein comprising a sequence of SEQ ID NO: 1 or 2; SEQ ID NO: 3 or 4; SEQ ID NO: 5 or 6; SEQ ID NO: 7 or 8; or SEQ ID NO: 9 or 10.

19. The method of claim 1, wherein the RuBisCO protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10.

20. The method of claim 1, wherein the RuBisCO protein isolate comprises a RuBisCO protein large subunit.

21. The method of claim 1, wherein the RuBisCO protein isolate comprises a RuBisCO protein small subunit.

22. The method of claim 1, wherein the RuBisCO protein isolate is from a plant in the Lemna genus.

23. The method of claim 1, wherein the RuBisCO protein isolate is from a Lemna minor.

24. The method of claim 1, wherein the RuBisCO protein isolate is from a Lemna aequinoctialis, Lemna disperma, Lemna ecuadoriensis, Lemna gibba, Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris.
